(19) United States
(12) Patent Application Publication
(10) Pub. No.: US 2026/0352782 A1
(43) Pub. Date: Nov. 5, 2026

(54) KNOWLEDGE-INTEGRATED QUERY ASSISTANCE

(71) Applicant: Cisco Technology, Inc., San Jose, CA (US)

(72) Inventors: Prasham Mehta, Rajkot (IN); Joe Rishon Manoj, Bangalore (IN); Sanket Zade, Nagpur (IN); Jayesh Lohani, Kathgodam (IN); Uday Arsikere Shivanand, Arsikere (IN); Rishabh Agrawal, Gwalior (IN); Neha Kohad, Bangalore (IN); Srastika, Udupi (IN)

(21) Appl. No.: 19/182,456

(22) Filed: Apr. 17, 2025

(51) Int. Cl. H04N 7/15

(52) U.S. Cl. CPC H04N 7/157; H04N 7/155

(57) ABSTRACT

Systems, devices, and methods employ a query assistance logic for knowledge-integrated query assistance. The query assistance logic obtains content associated with a meeting, for example, a virtual meeting, prior to an initiation of the meeting. The query assistance logic hosts the meeting where the content is presented. The query assistance logic receives at least one query associated with the content during the meeting, and retrieves a context for the meeting based on the content and the query. The query assistance logic generates at least one response to the query using an Artificial Intelligence (AI) model based on the context. The query assistance logic generates one or more prompts for the AI model based on the query, and determines the response(s) to the query based on an output of the AI model for the prompt(s). The query assistance logic utilizes, for example, retrieval-augmented generation, to generate the response(s) to the query.

The present disclosure relates to digital communication. More particularly, the present disclosure relates to providing knowledge-integrated query assistance in a meeting environment.

### BACKGROUND

The exponential growth and advancement of digital technologies have reshaped how humans communicate and collaborate, making virtual meetings more useful than ever. As entities such as businesses, educational institutions, organizations, or the like may increasingly rely on digital tools for remote work and learning, virtual meetings may offer a practical solution for overcoming geographical barriers and time constraints. Technologies such as high-speed internet, cloud computing, and video conferencing platforms may enable seamless communication, allowing individuals and teams to connect in real time regardless of location. This shift towards virtual meetings may not only enhance flexibility and productivity but can also help the entities maintain continuity during disruptions such as a global pandemic. As digital technologies continue to evolve, the need for virtual meetings may grow further, fostering more inclusive, efficient, and enhanced methods to collaborate.

However, in a meeting environment where professional meetings and presentations including, for example, team meetings, project demonstrations, knowledge transfer sessions, or the like are held, there may be difficulties in streamlining the flow of information and communication. Meetings may often experience inefficiencies due to the time-consuming nature of Question and Answer (Q&A) sessions, which can disrupt a flow of a meeting and extend a duration of the meeting. Moreover, participants of the meeting may frequently have queries about content being displayed during the meeting, but may not be able to get their queries answered promptly to maintain engagement and understanding. Further, moderators or hosts of the meeting may face difficulties in maintaining a smooth presentation flow while simultaneously managing and responding to the queries of the participants. Furthermore, there may be instances where queries that are beyond the immediate knowledge of the moderators but are covered within a content guide, may arise, necessitating a mechanism to provide prompt, accurate, and comprehensive answers.

### SUMMARY OF THE DISCLOSURE

Systems, devices, and methods for knowledge-integrated query assistance in a meeting environment in accordance with embodiments of the disclosure are described herein. In many embodiments, a device comprises one or more processors and a memory communicatively coupled to the one or more processors. The memory comprises a query assistance logic configured to: obtain content associated with a meeting, receive at least one query associated with the content during the meeting, retrieve a context for the meeting based on the content and the at least one query, and generate at least one response to the at least one query using an Artificial Intelligence (AI) model based on the retrieved context.

In a number of embodiments, the content is obtained prior to an initiation of the meeting.

In a variety of embodiments, the content is obtained during the meeting.

In various embodiments, the query assistance logic is further configured to vectorize the obtained content and store the vectorized content in a vector store.

In more embodiments, at least part of the retrieved context is based on the vectorized content.

In additional embodiments, the query assistance logic is further configured to receive a transcript of the meeting, vectorize the received transcript, and store the vectorized transcript in a vector store.

In further embodiments, at least part of the retrieved context is based on the vectorized transcript.

In still more embodiments, the query assistance logic is further configured to store history of the meeting in a database.

In still further embodiments, at least part of the retrieved context is based on the stored history.

In still additional embodiments, the at least one response to the at least one query is generated based on retrieval-augmented generation.

In some more embodiments, the query assistance logic is further configured to render the at least one response, on a user interface associated with the meeting, in at least one of real-time or near-real time.

In yet various embodiments, the query assistance logic is further configured to update the context of the meeting in a database based on a progress of the meeting.

In yet more embodiments, the query assistance logic is further configured to execute the AI model to generate the at least one response to the at least one query.

In still yet more embodiments, the AI model is a large language model.

In many further embodiments, the query assistance logic is further configured to: generate one or more prompts for the AI model based on the retrieved context, and input the one or more prompts to the AI model.

In many additional embodiments, the at least one response to the at least one query is generated based on an output of the executed AI model for the one or more prompts.

In still yet further embodiments, the meeting is a virtual meeting.

In still yet additional embodiments, the memory comprises a query assistance logic that is configured to: host a meeting where content is presented, receive at least one query associated with the content, generate one or more prompts for an AI model based on the at least one query, and determine at least one response to the at least one query based on an output of the AI model for the one or more prompts.

In several embodiments, the generation of the one or more prompts is based on a context associated with at least one of: the content, a transcript of the meeting, or a history of the meeting.

In several more embodiments, the query assistance logic is further configured to: tag one or more sentences in the transcript with a respective timestamp, and render, on a user interface associated with the meeting, the at least one response with a navigation pointer corresponding to the respective timestamp of at least one sentence of the one or more sentences in the transcript.

In numerous embodiments, the query assistance logic is further configured to receive the presented content prior to an initiation of the meeting.

In numerous additional embodiments, a method comprises: obtaining content associated with a meeting, receiving at least one query associated with the content during the meeting, retrieving a context for the meeting based on the content and the at least one query, and generating at least one response to the at least one query using an AI model based on the retrieved context.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently disclosed embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram illustrating various subsets of Artificial Intelligence (AI) in accordance with various embodiments of the disclosure;

FIG. 2 is a block diagram illustrating different methods of machine-based learning in accordance with various embodiments of the disclosure;

FIG. 3 is a block diagram illustrating a machine learning lifecycle in accordance with various embodiments of the disclosure;

FIG. 4 is a schematic diagram illustrating an example neural network in accordance with various embodiments of the disclosure;

FIG. 5 is a block diagram illustrating a system for knowledge-integrated query assistance in a meeting environment in accordance with various embodiments of the disclosure;

FIG. 6 is a message flow diagram illustrating provision of knowledge-integrated query assistance in a meeting environment in accordance with various embodiments of the disclosure;

FIG. 7 is a flowchart depicting a process for knowledge-integrated query assistance in a meeting environment in accordance with various embodiments of the disclosure;

FIG. 8 is a flowchart depicting a process for knowledge-integrated query assistance in a meeting environment based on actions of a facilitator of a meeting in accordance with various embodiments of the disclosure;

FIG. 9 is a flowchart depicting a process for knowledge-integrated query assistance based on one or more prompts generated for an AI model in accordance with various embodiments of the disclosure;

FIG. 10 is a flowchart depicting a process for knowledge-integrated query assistance in a meeting environment based on actions of a participant of a meeting in accordance with various embodiments of the disclosure; and

FIG. 11 is a conceptual block diagram of a device suitable for configuration with a query assistance logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, systems, devices, and methods are discussed herein for knowledge-integrated query assistance in a meeting environment. Knowledge-integrated query assistance may refer to query assistance provided, for example, through software systems or applications that integrate, utilize, and manage knowledge to enhance their functionality and decision-making processes. These applications may combine data, information, and insights from various sources including, for example, databases, experts, and real-time inputs, to provide smarter, more informed outcomes such as responses to queries. The meeting environment may refer to a digital space or platform where participants interact, collaborate, and engage with content and each other during a meeting. The meeting environment may encompass tools such as audio tools, video tools, screen sharing tools, collaboration tools, etc., technologies, and features such as message features, chat features, etc., to facilitate communication and participation.

In the meeting environment where professional meetings and presentations including, for example, team meetings, project demonstrations, knowledge transfer sessions, or the like are held, there may be difficulties in streamlining the flow of information and communication. Meetings may often experience inefficiencies due to the time-consuming nature of Question and Answer (Q&A) sessions, which can disrupt a flow of a meeting and extend a duration of the meeting. Moreover, participants of the meeting may frequently have queries about content being displayed during the meeting, but may not be able to get their queries answered promptly to maintain engagement and understanding. Further, moderators, hosts, or presenters, herein referred to as “facilitators,” of the meeting may face difficulties in maintaining a smooth presentation flow while simultaneously managing and responding to the queries of the participants. Furthermore, there may be instances where queries that are beyond the immediate knowledge of the facilitators but are covered within a content guide, may arise, necessitating a mechanism to provide prompt, accurate, and comprehensive responses.

The present disclosure addresses the above-mentioned challenges by providing systems, devices, and methods for knowledge-integrated query assistance in a meeting environment. In many embodiments, the systems, devices, and methods discussed herein may implement an Artificial Intelligence (AI)-based query assistance logic integrated with a meeting application platform, for example, a web conferencing platform, a video conferencing platform, or the like. In a number of embodiments, the AI-based query assistance logic may refer to an AI-based application configured to provide knowledge-integrated query assistance in a meeting environment hosted by the meeting application platform. The meeting application platform may, for example, be a cloud-based web or video conferencing platform implemented in a cloud computing environment. The AI-based query assistance logic may allow facilitators, for example, moderators, hosts, presenters, or the like, associated with a meeting to upload content before or during the meeting. The AI-based query assistance logic may then utilize the pre-uploaded content to provide accurate and contextually relevant responses to queries asked by one or more participants of the meeting, thereby ensuring that the responses are based on the most up-to-date and pertinent information available.

In a variety of embodiments, the systems, devices, and methods discussed herein may implement a knowledge-integrated system, for example, a Retrieval-Augmented Generation (RAG)-based query assistance system that may combine retrieval and generation functions, allowing for more accurate and contextually relevant outputs in tasks such as natural language processing, answering queries, or content creation. In various embodiments, the RAG-based query assistance system may employ a RAG-based pipeline configured to provide accurate and contextually relevant responses to the queries of the participants in real time or near-real time. In more embodiments, the RAG-based query assistance system may be configured as a RAG-based Q&A assistant for meetings, for example, virtual meetings. In additional embodiments, the AI-based query assistance logic may preserve individual chat context from the meeting by storing chat history per session in a database, ensuring that an AI model can maintain context and continuity throughout the meeting. In many embodiments, the stored chat context may include historical meeting transcripts, previous query-response pairs, participant details (such as speaker identities and roles), session metadata (e.g., timestamps, topics discussed, or agenda items), and associated semantic tags. Additionally, it may contain structured summaries or key points extracted from prior interactions, enabling semantic relevance searches and context-aware retrieval. It is envisioned that such contextual information, when stored, vectorized, and indexed, significantly enhances the ability of the AI-based query assistance logic to generate accurate, personalized, and situationally relevant responses during real-time interactions or subsequent meeting-related queries.

The AI-based query assistance logic may respond to the queries based on the context set before the meeting. Uploading content associated with the meeting prior to an initiation of the meeting may allow the AI-based query assistance logic to be well-prepared with information even before the meeting begins. This preparation may lead to more efficient and productive meetings, as the participants can receive informed responses to their queries quickly and accurately based on RAG. The RAG-based based query assistance system may enhance generative models by grounding generated content in real-world knowledge, making the generative models more capable of answering complex queries or generating precise, factually supported responses. Further, in further embodiments, the AI-based query assistance logic can answer queries that may be beyond a facilitator's understanding about a topic or a question by citing responses from the uploaded content. Furthermore, by providing precise and contextually relevant responses, the AI-based query assistance logic may reduce the time spent searching for information or clarifying points during the meeting.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. The executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in numerous additional embodiments, may alternatively be embodied by or implemented as a component.

A circuit, as used herein, comprises a set of one or more electrical and/or electronic components providing one or more pathways for electric current. In further additional embodiments, a circuit may include a return pathway for electric current, so that the circuit is a closed loop. In still more embodiments, however, a set of components that does not include a return pathway for electric current may be referred to as a circuit (e.g., an open loop). For example, an integrated circuit may be referred to as a circuit regardless of whether the integrated circuit is coupled to ground as a return pathway for electric current or not. In still further embodiments, a circuit may include a portion of an integrated circuit, an integrated circuit, a set of integrated circuits, a set of non-integrated electrical and/or electrical components with or without integrated circuit devices, or the like. In still additional embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages, or the like) or other discrete electrical devices, in electrical communication with one or more other components through electrical lines of a PCB or the like. Each of the functions and/or modules described herein, in various embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

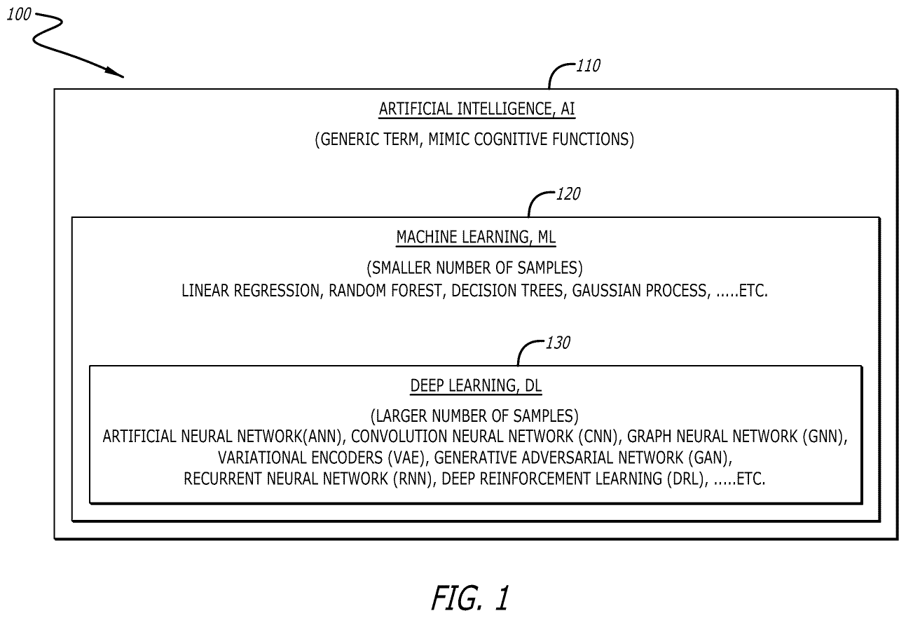

Referring to FIG. 1, a schematic diagram 100 illustrating various subsets of Artificial Intelligence (AI) 110 in accordance with various embodiments of the disclosure is shown. AI 110 is typically understood in the art to be the development of machines and algorithms that mimic human intelligence, for example, by optimizing actions to achieve certain goals. At its core, AI 110 often involves designing algorithms and models that mimic cognitive functions, such as learning, reasoning, problem-solving, perception, and even language understanding. Unlike conventional computer programs that follow a fixed set of instructions, AI systems can adapt, improve, and make decisions based on input data and environmental interactions.

AI 110 can be considered a generic term because AI 110 encompasses a wide range of subfields and techniques, from simple rule-based systems to advanced machine learning and deep learning models. These AI techniques are utilized for simulating various aspects of human cognition. For example, Machine Learning (ML) 120 allows computers to learn from data patterns without explicit programming for each task, while Natural Language Processing (NLP) enables machines to understand and generate human language.

Deep Learning (DL) 130, a more advanced branch of AI 110, utilizes neural networks to automatically learn complex patterns from large datasets, akin to information processing by the human brain. This versatility makes AI 110 a powerful tool across diverse applications including, for example, virtual assistants, voice assistants, Question and Answer (Q&A) systems, anomaly analysis, image recognition, autonomous driving, and materials discovery.

A goal of AI 110 is often to create systems that can function autonomously and intelligently in real-world scenarios. As AI 110 continues to evolve, AI 110 can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

ML 120 is a subset of AI 110 that focuses on the development of algorithms and statistical models that enable computers to learn and make decisions from data without explicit programming. In conventional programming, a computer is given a fixed set of rules to follow, but ML 120 can shift this paradigm by allowing systems to identify patterns, adapt, and improve their performance based on the data they encounter. This data-driven approach makes ML 120 particularly valuable for tasks that are too complex or dynamic to define using straightforward rules, such as answering complex queries, determining patterns associated with meeting events, recognizing images, or predicting consumer behavior. In various embodiments described herein, machine learning methods may be utilized, for example, for answering complex queries, generating relationship graphs, identifying correlations between documents, identifying correlations between events, or the like.

ML models can be configured to analyze large amounts of data to identify trends and relationships that inform their predictions or classifications. The process typically involves three stages: training, validation, and testing. During training, the ML model learns from a dataset by adjusting its internal parameters to minimize errors between its predictions and the actual results. Techniques such as linear regression, decision trees, random forests, and Gaussian processes are commonly utilized in ML 120. These algorithms can handle various data types, including numerical, categorical, and structured datasets such as spreadsheets or grids. One of the strengths of ML 120 is its ability to generalize from training data to make accurate predictions on new, unseen data. In many embodiments described herein, the training data may be generated from content associated with a meeting, chat history, transcripts, and contexts stored, for example, in a database, among other sources.

However, conventional ML methods may rely heavily on feature engineering, wherein human experts manually identify the most relevant features or patterns within the data. For example, when using ML 120 for answering queries, an expert may need to extract features such as keywords, named entities, parts of speech, syntax of a sentence, semantic features, context, sentiment, emotion, domain, graph features, knowledge from various sources, or the like, before feeding them into the ML model. This requirement can limit the scalability of conventional ML approaches, especially when dealing with large, unstructured datasets such as images, text, or graphs. Additionally, ML algorithms may often work best when provided with relatively structured data, and they often need a reasonable number of samples, for example, more than 100, to learn effectively.

DL 130 is a specialized subset of ML 120 that employs multi-layered artificial neural networks to automatically learn complex patterns and representations from large, often unstructured datasets. Inspired by the way the human brain processes information, DL 130 includes interconnected layers of “neurons” that can adaptively change as they are exposed to more data. Unlike conventional ML methods, which require manual feature engineering to identify data characteristics, DL models can automatically extract features directly from raw data, such as images, text, or data structures. This automated feature extraction allows DL 130 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as entity or object data, event data, action data, relationship data, document data, citations, references, shared concepts, network structures, atomic interactions, or the like. GNNs can learn the dependencies and relationships within graph-like structures, which may facilitate predicting properties of complex patterns, document data, meeting content, network structures, and materials. For example, the features of meeting content may be modeled as a graph and may be input into a GNN for summarizing key points of a presentation, organizing or reordering content based on its logical flow, identifying main topics of the presentation, suggesting additional slides, content, or resources based on the presentation, or the like. By organizing the features of the meeting content into a graph structure, situations where unknown patterns generated by previously unprocessed content may be handled optimally. RNNs and their variants, such as Long Short-Term Memory (LSTM) networks, are suited for sequential data such as time series or NLP, allowing for the analysis and generation of textual information or the prediction of temporal patterns in scientific research.

One of the defining characteristics of DL 130 is its requirement for large datasets (typically over 500 samples for example) to effectively train neural networks. While the deep, multi-layered structure of these networks enables them to capture highly complex and abstract representations of the data, they also demand significant computational power. Techniques such as Variational Autoencoders (VAEs) and Generative Adversarial Networks (GANs) add to the versatility of DL 130 by enabling the generation of new data samples that resemble a training dataset, aiding in areas such as materials discovery and content creation. Deep Reinforcement Learning (DRL) combines neural networks with decision-making processes to solve problems that involve optimization and control, further expanding the application potential of DL 130. In summary, the ability of DL 130 to automatically learn from raw, unstructured data and model intricate patterns makes DL 130 a powerful tool in AI 110, particularly for complex domains such as image recognition, NLP, and materials science.

Artificial Neural Networks (ANNs or sometimes merely NNs) are often a foundation of a DL system. The basic unit of a neural network is typically a perceptron, which can take inputs, assign weights to these inputs, and combine them to produce an output. The final output is then passed through an activation function, for example, a Rectified Linear Unit (ReLU), a sigmoid, or a hyperbolic tangent, to introduce non-linearity, which enables the network to model complex patterns.

Neural networks are typically trained through a process of backpropagation, where predictions of an AI system are compared against a known output, and a loss function is utilized to measure the difference between the prediction and the actual result. The weights assigned by the neural network can be adjusted through a process called gradient descent, which can be configured to minimize the loss function over time. However, the training process can be prone to problems such as overfitting, where the ML model performs well on the training data but poorly on new data. To counter this, techniques such as regularization (e.g., dropout), early stopping, and mini-batches can be utilized to prevent the neural network from becoming overly specialized to the training dataset.

CNNs are a specific type of ML neural network designed to work particularly well with meeting content, making them highly relevant for recognizing and classifying images, charts, diagrams, or other visual elements in presentation slides, which may be subject to processing. As those skilled in the art will recognize, CNNs typically utilize specialized layers known as convolutional layers, which apply filters (also known as kernels) to the input data. These filters slide over the input (e.g., an input power value), detecting patterns such as edges or textures, which are then passed to the next layer for further processing. CNNs can automatically learn and extract relevant features from raw data without the need for manual feature engineering. Furthermore, pooling layers (e.g., max-pooling or average pooling) are often added after convolutional layers to reduce the dimensionality of the data, helping to make the AI system more efficient while retaining the most important information. After several layers of convolutions and pooling, the CNN can output a prediction, such as whether a meeting event is normal, critical, or successful.

While CNNs are well-suited for grid-based data like images, many real-world problems can involve non-grid data, such as free-form text that does not follow a structured table or list format, photographs, flowcharts, sketches, artistic representations, or the like. This type of data may better be represented as a graph, where nodes represent entities (e.g., slides, text blocks, images, topics/subtopics, sections, or the like) and edges represent relationships between them (e.g., slide-to-slide relationships, textual relationships, content dependencies, topic and concept connections, or the like). Thus, Graph Neural Networks (GNNs) can be utilized to operate on such graph-based data.

In GNNs, information is passed between the nodes through the edges in a process called message passing. This allows the neural network to capture dependencies and relationships within the graph structure. GNNs can aggregate information from neighboring nodes, which is utilized in predicting properties that depend on the current/local structure, such as the behavior of the meeting content.

Generative models aim to learn the underlying distribution of a dataset and generate new samples that resemble the original data. Two common types of generative models are VAEs and GANs. VAEs are often configured to work by encoding data into a lower-dimensional latent space and then decoding the data back into its original form, which allows for the generation of new data by sampling points from the latent space. This can be utilized when attempting to construct a graph based on features of documentation and meeting content. Similarly, GANs include two components: a generator that creates fake or generated data and a discriminator that attempts to distinguish between real data and fake data. The two components are trained in a competitive process where the generator attempts to “fool” the discriminator, leading to increasingly realistic generated data. This type of process may be utilized to produce synthetic samples that resemble the training data, which can help augment the training dataset.

Reinforcement Learning (RL) involves an agent learning to make decisions by interacting with an environment and receiving feedback, for example, rewards, penalties, or the like based on its actions. Deep Reinforcement Learning (DRL) combines RL with DL techniques, allowing agents to learn from high-dimensional inputs, such as images or complex content simulations.

In Q&A systems, DRL can be utilized in scenarios where an optimal decision needs to be made, such as improving the ability of these systems to provide more relevant and accurate responses by learning from interactions with users based on various features extracted, for example, from documents, meeting content, chat histories, etc. The combination of RL and DL 130 can allow for learning from raw data, making it a powerful tool for dynamic and real-time decision-making for Q&A systems.

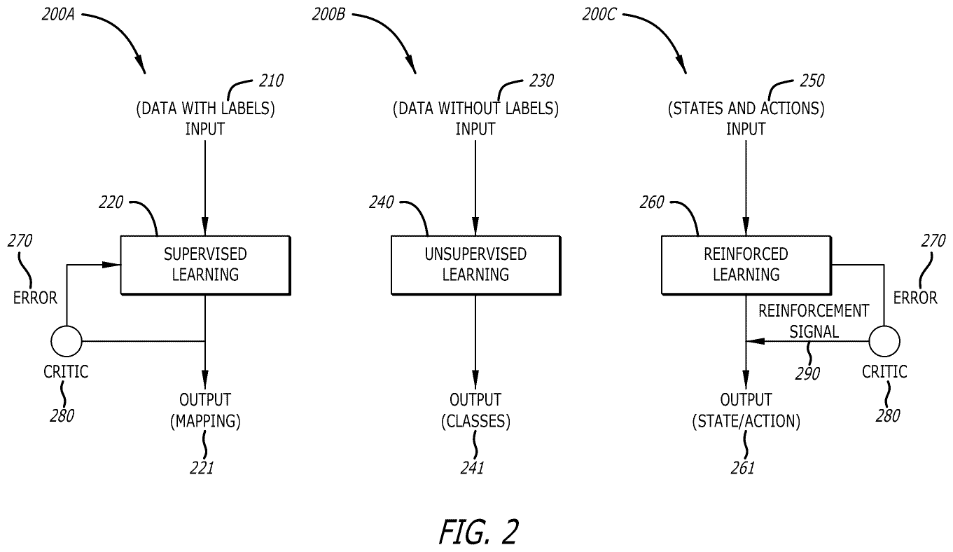

Although a specific embodiment for various subsets of artificial intelligence suitable for carrying out the various steps, processes, methods, and operations described herein is discussed with respect to FIG. 1, any of a variety of systems and/or processes may be utilized in accordance with embodiments of the disclosure. For example, another subset such as transformer networks, capsule networks, or the like may be present and available for use within AI 110. Those skilled in the art will recognize that the schematic diagram 100 presented in FIG. 1 is simplified for illustration purposes and various methods and techniques may interact with other areas (ML 120 with DL 130, etc.). The elements depicted in FIG. 1 may also be interchangeable with other elements of FIGS. 2-11 as required to realize a particularly desired embodiment.

Referring to FIG. 2, a block diagram illustrating different methods of machine-based learning in accordance with various embodiments of the disclosure is shown. In many embodiments, an ML model is defined as a mathematical representation of an output of a training process. An ML model is often considered similar to computer software designed to recognize patterns or behaviors based on previous experience or data. An ML algorithm can discover patterns within training data, and output an ML model which can capture these patterns and make predictions on new data.

ML models may be interpreted as devices that have been trained to find patterns within new data and make predictions. These ML models can be represented as complex mathematical functions that would be impractical for a human to calculate, that takes requests in the form of input data, makes predictions on input data, and then provides an output in response. These ML models can be trained over a set of data, and then the ML models may be provided an algorithm or other task to reason over the data, extract patterns from feed data, and learn from that data. Once the ML models are trained, the ML models can be utilized to predict a new and previously unseen dataset.

There are various types of ML models available based on different business goals and datasets available. Often, based on the desired application, ML models can be configured as or settled into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 2, a supervised learning system 200A is shown. The supervised learning system 200A can be configured with a supervised learning model 220 that accepts input data 210 and generates output data 221. The output data 221 is often reviewed by a critic 280 that can determine an error 270 that is fed back into the supervised learning model 220 for use in updating.

Supervised learning systems 200A are often considered the simplest ML model to understand which input data, for example, training data, has a known label or result as an output. The supervised learning model 220 can, therefore, be understood to work on the principle of input-output pairs. As such, a function can be trained using a training dataset, which is then applied to unknown data to make some predictions. Supervised learning is task-based and mostly tested on labeled datasets.

Supervised learning systems 200A may often involve one or more regression problems. In regression problems, the output is a continuous variable. Examples of commonly utilized regression models include linear regression, decision trees, and random forests. Linear regression is typically the most straightforward ML model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this linear equation may be represented in the form of a line: y=bx+c. A typical aim of a linear regression-based model can be to find an optimal fit line that best fits available data points. Linear regression can be extended to multiple linear regressions (finding a plane of best fit in a higher dimensional space) and polynomial regressions (finding the best fit curve).

Decision trees are also popular ML models that can be utilized for both regression and classification problems. A decision tree utilizes a tree-like structure of decisions along with their possible consequences and outcomes. In a decision tree, each internal node is utilized to represent a test on an attribute while each branch is utilized to represent the outcome of the test. The more nodes a decision tree has, the more accurate the result will be. This may be utilized when making decisions related to network issues and their separation. Decision trees are intuitive and easy to implement, but may lack accuracy depending on computational or time resources available.

Random forests are an ensemble learning method, which may include a large number of decision trees. For example, each decision tree in a random forest predicts an outcome, and the prediction with a majority of votes is considered as the outcome. A random forest model can be utilized for both regression and classification problems. For a classification task, the outcome of the random forest may be taken from the majority of votes. Whereas in a regression task, the outcome can be taken from a mean or an average of the predictions generated by each tree.

Classification models are the other type of supervised learning, which can be utilized for generating conclusions from observed values in one or more categorical forms. For example, a classification model can identify if an electronic mail (email) is spam or not; whether presentation slides include a title slide, an introduction slide, a content slide, or a conclusion slide, etc. Classification algorithms can also be utilized for predicting between two or more classes and/or categorize an output into different groups. For these classification systems, a classification model can be designed that classifies a dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be utilized for solving various classification problems in machine learning systems. These processes are similar to linear regression but are often utilized for predicting categorical variables. While some variations can be configured to generate a prediction as an output in either “yes” or “no,” 0 or 1, “true” or “false,” etc., in a number of embodiments, the system can instead be configured to not give exact values, but instead provide probabilistic values between zero and one.

Another classification process that can be utilized is a Support Vector Machine (SVM) which is widely utilized for classification and regression tasks. However, the main aim of the SVM is to find the best decision boundaries in an N-dimensional space, which can be utilized for segregating data points into classes, and generate a best decision boundary often known as a hyperplane. SVM processes can select an extreme vector to find a hyperplane, wherein this vector is known as a support vector.

Naïve Bayes is another popular classification algorithm utilized in machine learning. This classification process is based on Bayes' theorem and follows a naïve (independent) assumption between features which is often based on the following formula:

$$P ( y \vert X ) = \frac{P ( X \vert y ) * P ( y )}{P ( X )}$$

This formula takes a class or target (y) and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as a posterior chance being a result of prior results times the likelihood divided by evidence available. Each Naïve Bayes classifier assumes that the value of a specific variable is independent of any other variable/feature. For example, if a fruit needs to be classified based on color, shape, and taste, yellow, oval, and sweet will be recognized as mango. In this example, each feature is independent of other features. Likewise, various embodiments herein can classify meeting content into categories such as text blocks, intents, style and tone, visual elements, or the like.

Further, in the embodiment depicted in FIG. 2, an unsupervised learning system 200B is shown. The unsupervised learning system 200B can be configured with an unsupervised learning model 240 that accepts input data 230 and generates an output 241. Unlike other model types, there are no critics or error signals to process. Unsupervised learning models 240 can implement a learning process opposite to supervised learning, which means the learning process enables a model to learn from an unlabeled training dataset. Based on the unlabeled training dataset, the unsupervised learning model 240 can predict the output 241. Using the unsupervised learning system 200B, the unsupervised learning model 240 can learn hidden patterns from the unlabeled training dataset by itself without any supervision. In a variety of embodiments, unsupervised learning models 240 are often utilized for performing tasks involving clustering, association rule learning, and/or dimensional reduction.

Clustering is an unsupervised learning technique that involves clustering or grouping the available data points into different clusters based on similarities and/or differences. The data points or objects with the most similarities remain in the same group, and they have no or very few similarities from other groups. Clustering algorithms can be utilized in various tasks such as, but not limited to, image segmentation, statistical data analysis, market segmentation, or the like. Some commonly utilized clustering algorithms that can be selected include, for example, K-means clustering, hierarchal clustering, Density-based Spatial Clustering of Applications with Noise (DBSCAN), etc.

Association rule learning is an unsupervised learning technique which finds unique relations among variables within a large dataset. In various embodiments, a primary aim of this type of learning algorithm is to find a dependency of one data item on another data item and map those variables accordingly to satisfy a desired outcome. For example, in more embodiments, an association rule system may be utilized for identifying interesting relationships, patterns, or co-occurrences between different elements within a presentation, such as slides, topics, or specific pieces of content. This learning algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and Frequent Pattern (FP)-growth algorithm.

In additional embodiments, the number of features/variables present in a dataset can be understood as the dimensionality of the dataset, and the technique utilized to reduce the dimensionality is known as a dimensionality reduction technique. Although more data provides more accurate results, more data can also affect the performance of the model/algorithm, for example, by yielding overfitting outcomes. In such cases, dimensionality reduction techniques can be utilized. Dimensionality reduction techniques involve converting a higher-dimensional dataset into a lower-dimensional dataset while also ensuring that the ensuing results provide similar information. Different dimensionality reduction methods can be utilized, such as, but not limited to, Principal Component Analysis (PCA), Singular Value Decomposition (SVD), etc.

Further, in the embodiment depicted in FIG. 2, a reinforcement learning system 200C is shown. The reinforcement learning system 200C can be configured with a reinforcement learning model 260 that accepts input data 250 and generates an output 261. In reinforcement learning, the reinforcement learning model 260 learns actions for a given set of states that lead to a goal state. In the embodiment depicted in FIG. 2, a critic 280 can receive or otherwise notice an error 270 within the reinforcement learning model 260 actions, and transmit a reinforcement signal 290 to adjust the outcome/output such that the “reward” or “punishment” is adjusted to better model the future behaviors or processing of the reinforcement learning model 260.

The reinforcement learning model 260 is a feedback-based learning model that can take feedback signals after each state or action by interacting with the environment. This feedback works as a reward (positive for each good action and negative for each bad action), and an AI agent's goal is to maximize the positive rewards to improve their performance. The behavior of the reinforcement learning model 260 in reinforcement learning is similar to that of human learning, as humans learn things by experiences as feedback and interact with an environment. Popular methods of reinforcement learning including Q-learning, State-Action-Reward-State-Action (SARSA), and deep Q-network.

Q-learning is one of the popular model-free algorithms of reinforcement learning, which is based on the Bellman equation. Q-learning often aims to learn a policy that can help an AI agent to take the best action for maximizing a reward under a specific circumstance. Q-learning can incorporate a Q-value for each state-action pair that indicates the reward to following a given state path, and tries to maximize that Q-value.

SARSA is an on-policy algorithm based on the Markov decision process. In further embodiments, SARSA can use the action performed by the current policy to learn the Q-value. The SARSA algorithm stands for State Action Reward State Action, which symbolizes the tuple (s, a, r, s′, a′). A Deep Q-Network (DQN) implements Q-learning within a neural network. The DON can be deployed within a big state space environment where defining a Q-table would be a complex task. In these embodiments, rather than using a Q-table, the DON utilizes Q-values for each action based on the state.

Although a specific embodiment for different methods of machine-based learning suitable for carrying out the various steps, processes, methods, and operations described herein is discussed with respect to FIG. 2, any of a variety of systems and/or processes may be utilized in accordance with various embodiments of the disclosure. For example, those skilled in the art will recognize that methods of learning described herein are generalized and may incorporate other types developed as well as a combination of one or more methods based on the goals of the desired application. The elements depicted in FIG. 2 may also be interchangeable with other elements of FIG. 1 and FIGS. 3-11 as required to realize a particularly desired embodiment.

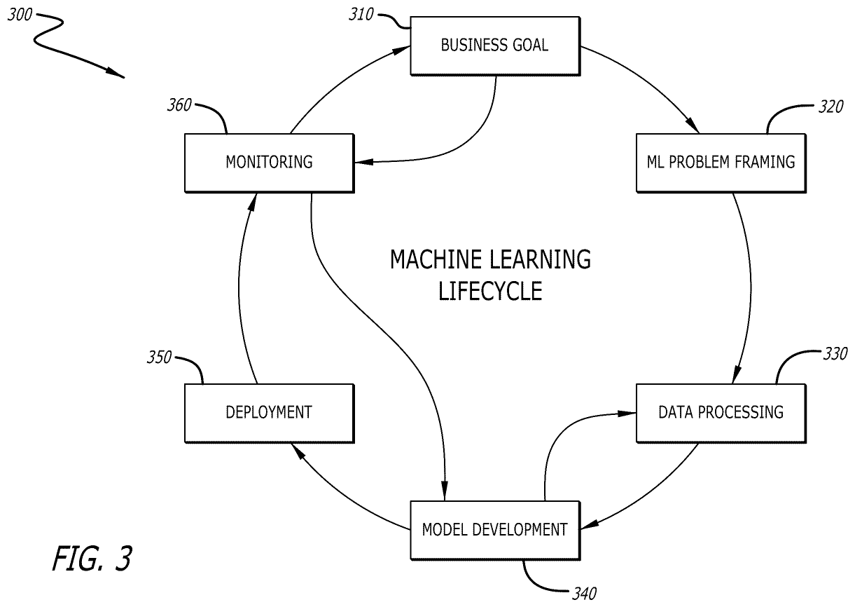

Referring to FIG. 3, a block diagram illustrating a machine learning lifecycle 300 in accordance with various embodiments of the disclosure is shown. While developing machine learning systems, the embodiment depicted in FIG. 3 can provide a framework for structuring the design and maintenance of these machine learning systems. The machine learning lifecycle 300 outlines various stages involved in building, deploying, and improving ML models to solve real-world problems. By following this structured process, businesses and organizations can ensure that their ML projects align with strategic goals, utilize data effectively, and adapt to changing conditions over time. This machine learning lifecycle 300 emphasizes that developing an ML model is not a one-time effort but an iterative process requiring ongoing monitoring and adjustment. A feedback loop inherent in the machine learning lifecycle 300 allows for continual refinement and optimization of the ML models to maintain their accuracy and relevance.

In many embodiments, a first stage of the machine learning lifecycle 300 includes identifying a business goal 310, which sets an overall direction and purpose for an ML project. Identifying the business goal 310 can involve understanding specific problems or opportunities within a business or a project that machine learning can address. A clear business goal 310 ensures that the project remains focused on delivering tangible value, whether it is classifying meeting issues or distinguishing between normal meeting events and successful meeting events. Without a well-defined business goal 310, it can be challenging to align subsequent stages of the machine learning lifecycle 300, as the choice of model, data processing methods, and performance metrics can all depend on what the business aims to achieve.

Establishing a proper business goal 310 can also involve engaging with key stakeholders and developers to gather requirements and set success criteria, which can provide a roadmap that outlines what success looks like and helps in framing an ML problem. For example, if the goal is to respond to queries related to content associated with a meeting, the project may focus on developing an ML model that utilizes meeting content extracted from uploaded documents for generating context for the meeting and responses to the queries based in the context. Clearly defined business goals not only help guide the project but also provide benchmarks for evaluating the effectiveness of the deployed ML model once the deployed ML model enters production.

Once the business goal 310 is established, various embodiments take a next step involving ML problem framing 320, wherein the business goal 310 is translated into a specific machine learning task. This can involve selecting the appropriate type of ML problem, such as classification, regression, clustering, or recommendation, and defining target variables or outputs. For example, if the business goal 310 is to respond to queries related to content associated with a meeting, the problem can be framed as a regression task where the ML model treats features of the queries such as query text such as length of a query, word frequency, or semantic meaning, context such as intent, user profile, or historical data, document features, past interaction data, domain knowledge, or the like as variables and a relevance score, a confidence score, or response time as a metric for generating responses to the queries. Proper ML problem framing 320 can determine particular data requirements, choice of model, and evaluation metrics.

During the stage of ML problem framing 320, it is also prudent to consider constraints and assumptions that may affect the development of the ML model. The constraints and assumptions may include, for example, data availability, computational resources, ethical considerations, or regulatory compliance. Properly framing the ML problem ensures that the development of the ML model aligns with the needs of the business and that the ML problem is broken down into manageable steps, ultimately increasing the project's chances of success.

Data processing 330 is a stage in many embodiments where raw data is collected, cleaned, and transformed into a format suitable for machine learning. This stage of the machine learning lifecycle 300 can involve gathering data from various sources, removing errors or inconsistencies, handling missing values, and normalizing or scaling features to ensure that the ML model can learn effectively. Feature engineering is often a part of this stage, where new features are derived from the raw data to capture more relevant information and improve model performance.

The quality and preparation of the utilized data can significantly impact the accuracy and reliability of the ML model. Inadequate or poorly processed data can lead to biased or inaccurate predictions, no matter how advanced the ML model is. Hence, data processing 330 can require or at least benefit from careful planning and iterative refinement. Once the data is processed, the data is typically split into training, validation, and test datasets to develop and evaluate the ML model, ensuring that the ML model generalizes well to new, unseen data.

Model development 340 is a stage, in a number of embodiments, where machine learning algorithms are selected, trained, and refined to create an ML model that addresses the framed problem. This stage can involve choosing an appropriate algorithm (e.g., decision trees, neural networks, support vector machines, or the like), setting up the architecture of the ML model, and defining hyperparameters that may guide the training process. The ML model is trained on the processed data to identify patterns and relationships that allow the ML model to make predictions or decisions.

During model development 340, the ML model can be evaluated using the validation dataset to finetune its parameters and improve performance. Techniques such as cross-validation, regularization, and hyperparameter tuning can be utilized to prevent overfitting and ensure the ML model generalizes well. If proper steps are taken, the result is an ML model that, once the ML model meets predefined performance metrics, is ready for deployment in a real-world environment. However, model development 340 often involves several iterations to optimize the ML model for the specific business goal, indicated by an arrow directed back to data processing 330.

In a variety of embodiments, deployment 350 is the stage of the machine learning lifecycle 300 where the developed ML model is integrated into a production environment to perform its intended tasks. This stage may involve setting up necessary infrastructure, such as Application Programming Interfaces (APIs) or cloud-based services, to allow the ML model(s) to process live data and generate predictions. Deployment 350 can transform the ML model from a research tool into a functional component of a business process or product, providing real-time insights, automations, or decisions.

Proper deployment 350 can also include setting up mechanisms for logging, error handling, and user access. Since real-world environments are often dynamic and differ from training conditions, deployment 350 may require continuous adaptation and updates to ensure the ML model(s) operates efficiently. This stage may define the success of the ML model because the ML model's success is not only determined by its performance metrics but also by its ability to provide actionable results that align with the business goal 310.

In various embodiments, monitoring 360 is an ongoing process of tracking the performance and behavior of the ML model after deployment 350. Monitoring 360 involves collecting data on the ML model's predictions, accuracy, latency, and error rates to detect issues such as concept drift, where changes in the underlying data patterns can degrade the accuracy of the ML model. By continuously monitoring 360, teams can identify when the performance of the ML model drops and requires retraining or adjustments to align with evolving data.

Monitoring 360 can also encompass aspects such as user feedback, security, and compliance, ensuring that the ML model remains effective, reliable, and ethical in its application. Monitoring 360 may serve as a feedback loop in the machine learning lifecycle 300, where insights gained from monitoring feedback into the earlier stages of the machine learning lifecycle 300, particularly data processing 330 and model development 340, to refine the ML model(s) as needed. This iterative process allows a machine learning system to adapt and maintain its alignment with the original business goal 310 over time.

Although a specific embodiment for a machine learning lifecycle 300 suitable for carrying out the various steps, processes, methods, and operations described herein is discussed with respect to FIG. 3, any of a variety of systems and/or processes may be utilized in accordance with embodiments of the disclosure. For example, the particular route of development of the ML model(s) may not follow this machine learning lifecycle 300 completely. As those skilled in the art will recognize, there are a variety of ways to develop AI products that include various iterative steps that aid in development and refinement of different ML models. The elements depicted in FIG. 3 may also be interchangeable with other elements of FIGS. 1-2 and FIGS. 4-11 as required to realize a particularly desired embodiment.

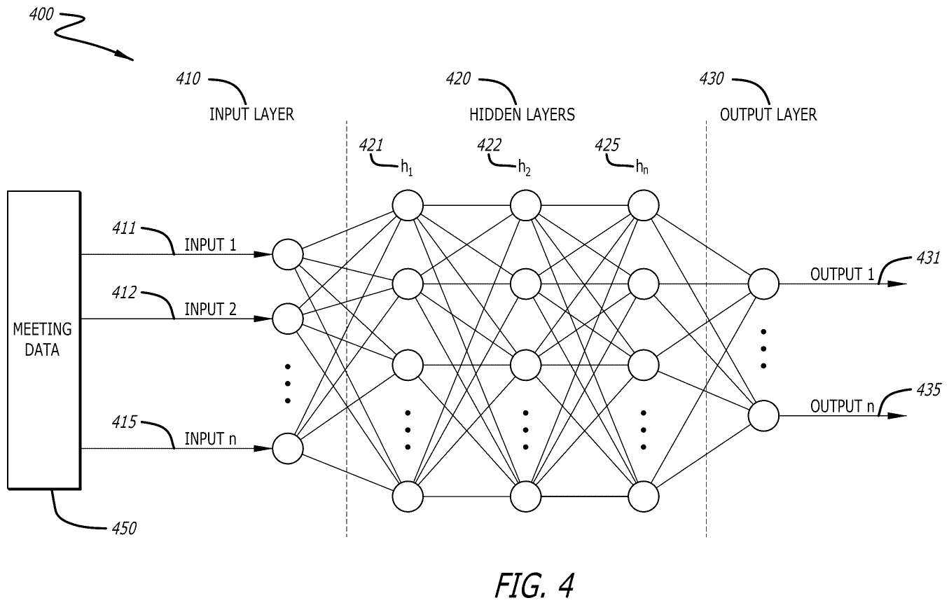

Referring to FIG. 4, a schematic diagram illustrating an example neural network 400 in accordance with various embodiments of the disclosure is shown. The embodiment illustrated in FIG. 4 specifically depicts a feedforward neural network with multiple layers. This type of network includes an input layer 410, one or more hidden layers 420, and an output layer 430. Each layer contains nodes or neurons that are interconnected, representing how data flows through the feedforward neural network. The input layer 410 can receive raw meeting data 450, which is then processed by the hidden layers 420 through weighted connections and activation functions. These hidden layers 420 can enable the feedforward neural network to learn complex patterns and relationships within the meeting data 450.

The final output layer 430 produces predictions or classifications of the feedforward neural network based on the processed meeting data. The interconnected nature of the nodes allows the neural network 400 to learn from the meeting data 450 during training by adjusting weights of connections to minimize prediction errors. This structure is the foundation of deep learning models, as adding more hidden layers 420 can create a deep neural network, capable of tackling highly complex tasks such as image recognition, NLP, and pattern detection in large datasets.

A perceptron or a single artificial neuron is the building block of ANNs and can perform forward propagation of information. For a set of inputs to the perceptron, weights and biases to shift the weights can be assigned. These inputs and weights can be multiplied out correspondingly together to obtain a sum output. Those skilled in the art may recognize tools such as, but not limited to, PyTorch, Tensorflow, and MXNet as training packages for common neural network tasks. However, it is contemplated that other tools may be developed specifically for the neural network tasks related to the embodiments described herein.

In many embodiments, weight matrices of the neural network 400 can be initialized randomly or obtained from a pre-trained model. These weight matrices can be multiplied with the input matrix or output from a previous layer and subjected to a nonlinear activation function to yield updated representations, which are often referred to as activations or feature maps. A loss function, also referred to as an objective function or an empirical risk, can often be calculated by comparing the output of the neural network 400 and known target value data.

Feedforward networks, such as the neural network 400 depicted in the embodiment of FIG. 4, are often configured as neural networks where information moves in one direction, from the input layer 410 through the hidden layers 420 to the output layer 430, without any cycles or loops. The feedforward networks are primarily utilized for tasks such as classification, regression, and simple pattern recognition, where each input is processed independently of others. In contrast, backpropagation is not a separate type of network but rather a training algorithm commonly utilized in both feedforward and other types of networks such as Recurrent Neural Networks (RNNs).

Backpropagation involves adjusting the weights of the neural network in a reverse direction, for example, from output to input, based on an error between a predicted output and an actual target during training. While feedforward describes the structure and data flow within the neural network, backpropagation is a technique utilized to optimize the model. Feedforward networks are utilized for straightforward tasks where input-output relationships are not sequential or time-dependent. However, for problems involving learning complex patterns over time, such as speech recognition or time-series analysis, neural networks such as RNNs or deep feedforward networks with many hidden layers, that employ backpropagation for training, may be utilized to capture these intricate dependencies.

Typically, in these network arrangements, the weights are iteratively updated via various methods including, but not limited to, stochastic gradient descent algorithms to help minimize the loss function until a desired accuracy is achieved. Most modern deep learning frameworks can facilitate this iterative update by using reverse-mode automatic differentiation to obtain partial derivatives of the loss function with respect to each network parameter through recursive application of a chain rule. Colloquially, this is also known as backpropagation. Common gradient descent algorithms can include, but are not limited to, Stochastic Gradient Descent (SGD), Adam, Adagrad, etc. Learning rate is one of the parameters in gradient descent. Except for SGD, all other methods utilize adaptive learning parameter tuning. Depending on the objective such as classification or regression, different loss functions such as Binary Cross Entropy (BCE), Negative Log Likelihood Loss (NLLL), or Mean Squared Error (MSE) can be utilized.

Neural network architecture is commonly utilized for a wide range of tasks in fields such as computer vision, NLP, financial forecasting, and materials science. For instance, the neural network architecture can be employed to recognize patterns in images such as identifying objects or faces, or to classify text of the meeting data 450 into categories such as classifying topics discussed during a meeting based on the content of a conversation or chat. The neural network architecture is also useful in regression problems, such as predicting stock prices or energy consumption, where input features can be processed to output continuous values. However, this is a general example of an AI model, illustrating how a feedforward neural network works. Depending on the problem, other methods and models may be more appropriate. For example, CNNs are often utilized for image processing tasks, while RNNs are suitable for sequential data such as time series data or text. Additionally, simpler models such as linear regression, decision trees, or SVMs may be sufficient if the problem is less complex, or a dataset is relatively small. The embodiment depicted in FIG. 4 is presented as an example ML solution that may be deployed within one or more methods or systems described herein.

In a number of embodiments, the input layer 410 is the first layer in the neural network 400 and serves as the initial point where raw meeting data 450 is introduced into the model. Each node (or neuron) in this input layer 410 represents an individual feature or variable from the dataset, allowing the neural network 400 to receive and process various types of data, such as features in the meeting data 450, pixel values in an image, numerical features in a spreadsheet, or words in a text document. For instance, in image recognition tasks, the input layer 410 can include nodes that correspond to pixel values of the image, providing the neural network 400 with visual information needed to identify objects or patterns. The number of nodes in the input layer 410 directly depends on the number of features present in the dataset. If there are one hundred features in the meeting data 450, the input layer 410 may typically have one hundred nodes, each conveying one piece of the information to the subsequent layers. In a variety of embodiments, the inputs of the neural network 400 are generally scaled, that is, normalized to have a zero mean and/or a unit standard deviation. Scaling can also be applied to the input of the hidden layers 420, for example, by utilizing batch or layer normalization to improve the stability of the neural network 400.

Unlike the hidden layers 420 and the output layer 430, the input layer 410 typically does not perform any computations or transformations on the data. The primary function of the input layer 410 is often to pass the input data to the next layer in the neural network 400, that is, the first hidden layer 421. However, it is often desired that the data fed into this first hidden layer 421 is preprocessed appropriately, such as being normalized or standardized, to ensure that the neural network 400 can learn efficiently. Proper preprocessing, for example, scaling numerical values or encoding categorical variables, can help the neural network 400 process data uniformly, facilitating more stable and faster convergence during training.

The design of the input layer 410 depends on the nature of the problem. For example, in NLP, the input layer 410 may represent words encoded as numerical vectors, while in time series analysis, each node may represent a data point in a sequence. While the input layer 410 itself does not modify the data, the input layer 410 sets the stage for the neural network 400 to extract complex patterns and relationships through the deeper layers. This flexibility in handling various types of input make the neural network 400 a powerful tool for a diverse set of applications.

With respect to the embodiments described herein, the input layer 410 may be configured with a plurality of inputs providing meeting data 450. For example, the ML model can be configured with a first input 411 configured as uploaded document data, a second input 412 configured with chat messages, while additional inputs can be added related to transcripts of the meeting. The nth input 415 can be configured in various embodiments to include audio data. However, as those skilled in the art will recognize, additional setups can be configured such that the inputs 411, 412, and 415 can be configured to also include different parameters such as participant interaction data, engagement level, response time, etc.

In more embodiments, the neural network 400 comprises a plurality of hidden layers 420. The embodiment depicted in FIG. 4 comprises a first hidden layer 421, a second hidden layer 422, and an nth hidden layer 425, which are denoted as h₁, h₂, and hₙ, respectively. In additional embodiments, the hidden layers 420 are disposed where the core of the ML model's learning and pattern recognition occurs. In each of the hidden layers 420, individual neurons receive inputs from the previous layer, apply a set of weights, add a bias, and pass the result through an activation function, for example, Rectified Linear Unit (ReLU), leaky ReLU, sigmoid, hyperbolic tangent (tanh), Swish, etc. This process can introduce non-linearity, allowing the neural network 400 to capture complex patterns in the data that simple linear models cannot. The intricate web of connections among neurons across layers helps the neural network 400 transform and process input features into representations that become progressively more abstract and useful for making predictions.

The first hidden layer 421, h₁, receives direct input from the input layer 410, transforming the raw meeting data 450 into an initial set of features. For example, in a Q&A system, the first hidden layer 421 may initiate differentiating between types of data such as textual data including chat history logs, transcripts, etc., audio data, video data, interaction data including chat, reactions, audio participation, etc. The output of the first hidden layer 421 is then passed to the second hidden layer 422, h₂, which builds upon the features identified by the first hidden layer 421. This deeper second hidden layer 422 may start recognizing more complex patterns, for example, identifying the tone of queries associated with meeting content included in the meeting data, identifying basic sentiment cues such as positive or negative words, identifying the tone of a dialog based on volume levels or loudness, recognizing periods of silence or pauses during speech, detecting voice inflections, or the like, by combining the lower-level features identified in the previous hidden layer. This can continue until a last, nth hidden layer 425, hₙ, continues this abstraction process, allowing the neural network 400 to recognize even higher-level, more detailed features, such as identifying eye movement patterns, gestures, patterns of conversation flow, reactions indicating engagement, or understanding intricate relationships in the input meeting data 450. With respect to the embodiments described herein, the hidden layers 420 may learn one or more patterns of the input meeting data 450 to extract higher-level features from the raw meeting data 450, thereby improving the ability of the ML model to perform knowledge-integrated query assistance in a meeting environment.

Each of the hidden layers 420 adds a level of complexity and abstraction to the learning capabilities of the neural network 400. The multi-layer structure can enable the neural network 400 to move from recognizing simple patterns in the first hidden layer 421 to highly complex, abstract concepts in the deeper hidden layers. The number of hidden layers 420 and neurons within them can vary depending on the complexity of the problem. More hidden layers 420 generally allow the neural network 400 to model more intricate functions, making deep neural networks especially effective for tasks such as image recognition, NLP, query assistance, and complex predictive modeling. However, adding more layers also increases the computational demand and the risk of overfitting, highlighting the need to carefully design and tune these hidden layers 420 for optimal performance.

In further embodiments, the output layer 430 is often the final layer in the neural network 400 and is responsible for producing predictions or classifications of the meeting data 450 for providing query assistance based on the information processed through the previous hidden layers 420. Each neuron in the output layer 430 can represent a specific outcome or category that the ML model can predict. In the embodiment depicted in FIG. 4, the outputs are labeled as “output 1” 431 to “output n” 435, indicating that the neural network 400 can be designed to have a varying number of outputs depending on the nature of the problem being solved. For example, in a binary classification such as successful meeting versus unsuccessful meeting, there would typically be a single output neuron that provides a probability score for one of the two classes/outcomes. In contrast, for multi-class classification, for example, categorizing topics of the meeting content into different types such as technical discussion, strategic planning, budgeting, marketing, team updates, or the like, the output layer 430 would contain multiple neurons, each corresponding to a different class.

The number of neurons in the output layer 430 can also be designed specifically for other types of tasks, such as regression, where the ML model can predict continuous values. In such cases, the output layer 430 may contain a single neuron representing a numerical prediction, such as a price of a house or a temperature forecast, etc. Alternatively, in complex applications such as multi-label classification, where each input can belong to multiple classes simultaneously, the output layer 430 could have multiple neurons, each representing a different class, with each neuron outputting a probability of the input belonging to that specific class.

The activation function utilized in the output layer 430 can vary based on the desired output. For binary classification, a sigmoid function is commonly utilized to produce a probability between 0 and 1. For multi-class classifications, a softmax function can be applied to output a set of probabilities that sum to 1, indicating the most likely class. For regression problems, a linear activation function is often utilized to output a continuous range of values. The flexibility in designing the output layer 430 allows the neural network 400 to be applied to a wide variety of tasks, from simple binary decisions to complex multi-output predictions, making them a versatile tool in artificial intelligence and machine learning.

Although a specific embodiment for an example neural network 400 suitable for carrying out the various steps, processes, methods, and operations described herein is discussed with respect to FIG. 4, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 4, which is an illustrative example that explains the basic concepts of neural networks and how they process information. The specific features and functions described herein are not intended to be limiting to this specific embodiment. The elements depicted in FIG. 4 may also be interchangeable with other elements of FIGS. 1-3 and FIGS. 5-11 as required to realize a particularly desired embodiment.

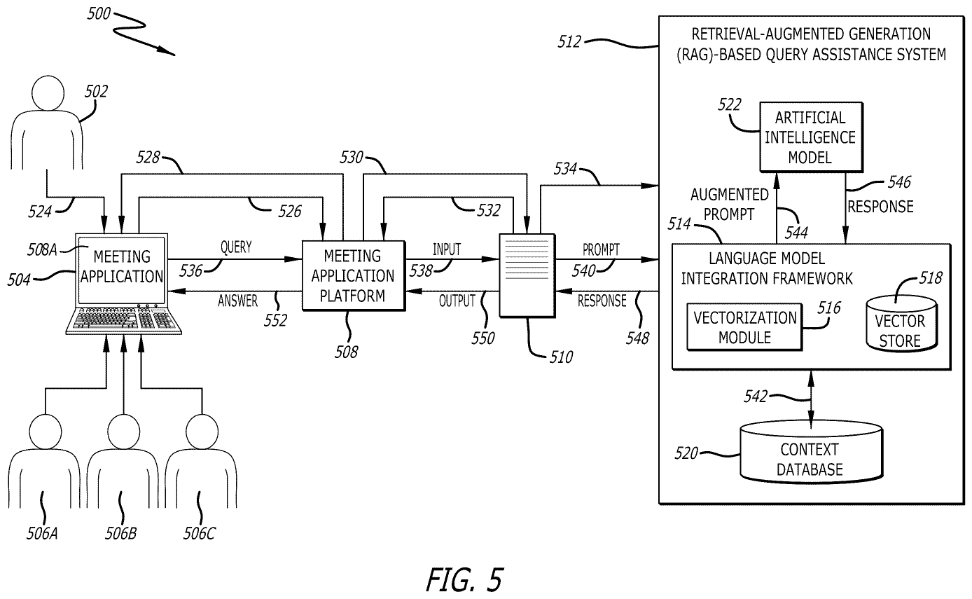

Referring to FIG. 5, a block diagram illustrating a system 500 for knowledge-integrated query assistance in a meeting environment in accordance with various embodiments of the disclosure is shown. In many embodiments, the system 500 may implement an AI-based query assistance logic integrated with a meeting application platform 508, for example, a web conferencing platform, a video conferencing platform, or the like. In a number of embodiments, the AI-based query assistance logic may refer to an AI-based application configured to provide knowledge-integrated query assistance in a meeting environment hosted by the meeting application platform 508. The meeting application platform 508 may, for example, be a cloud-based web or video conferencing platform implemented in a cloud computing environment, which may provide an on-demand network access to a shared pool of configurable, computing, physical, and logical resources. The cloud computing environment may refer to a processing environment including configurable, computing, physical, and logical resources, for example, networks, servers, storage media, virtual machines, applications, services, or the like, and data distributed over a network such as the internet.

The AI-based query assistance logic may allow facilitators, for example, moderators, hosts, presenters, or the like, of a meeting to upload content associated with the meeting, before or during the meeting. The content associated with the meeting may herein be referred to as “meeting content.” In an example, the meeting may be a virtual meeting such as an online gathering or conference that takes place over the Internet, where participants, for example, the participants 506A, 506B, and 506C of the meeting, regardless of their physical location, communicate and collaborate in real time by utilizing digital tools. The participants 506A, 506B, and 506C may herein be collectively referred to as “participants 506A-506C.” The participants 506A-506C may refer to attendees or audience of the meeting who participate and interact with the meeting content presented by a facilitator 502 during the meeting. The meeting may involve audio, video, and/or text communication and may include features such as screen sharing, file sharing, and collaboration on documents and other meeting content. The AI-based query assistance logic may utilize the pre-uploaded meeting content to provide accurate and contextually relevant responses to queries asked by one or more of the participants 506A-506C of the meeting, thereby ensuring that the responses are based on the most up-to-date and pertinent information available.

The meeting application platform 508 may be accessible to a facilitator 502, for example, a moderator, a host, or a presenter of the meeting, and the participants 506A-506C of the meeting through a broad spectrum of technologies and user devices, for example, a user device 504. The meeting application platform 508 may be accessible to the user device 504 via a network. Examples of the user device 504 may include a personal computer with access to the internet, a tablet computing device, a mobile computer, a mobile phone, an internet-enabled cellular phone, a smartphone, a portable computing device, a laptop, a personal digital assistant, a touch-centric device, a workstation, a client device, a portable electronic device, a network-enabled computing device, an interactive network-enabled communication device, a device capable of running a web browser, or any other suitable computing equipment or combinations of multiple pieces of computing equipment. In a variety of embodiments, the meeting application platform 508 may operate, for example, as a web or video conferencing hub, that integrates video conferencing, messaging, and collaboration tools for enhancing the meeting environment.

In various embodiments, the meeting application platform 508 may be operably coupled to a server, for example, a web server 510, via a network. In more embodiments, the meeting application platform 508 may host multiple applications including, for example, a meeting application, that may interact with the web server 510 via Application Programming Interfaces (APIs) such as Representational State Transfer (REST) APIs. The APIs may be utilized for actions including, for example, sending messages, creating meetings, accessing the meeting content, or the like depending on the functionality of the meeting application.

In additional embodiments, the system 500 may include a knowledge-integrated system, for example, a Retrieval-Augmented Generation (RAG)-based query assistance system 512. In further embodiments, the RAG-based query assistance system 512 may be configured as a RAG-based Q&A assistant for the meeting. In still more embodiments, the web server 510 may be operably and communicatively coupled to the RAG-based query assistance system 512 via a network. The network utilized for connections and communications between various devices of the system 500, for example, between the user device 504 and the meeting application platform 508, between the meeting application platform 508 and the web server 510, or between the web server 510 and the RAG-based query assistance system 512 may include, for example, the internet, satellite internet, an intranet, a wired network, a wireless network, a communication network that implements Bluetooth® of Bluetooth Sig, Inc., a network that implements Wi-Fi® of Wi-Fi Alliance Corporation, an Ultra-WideBand (UWB) communication network, a wireless Universal Serial Bus (USB) communication network, a communication network that implements ZigBee® of ZigBee Alliance Corporation, a General Packet Radio Service (GPRS) network, a mobile telecommunication network such as a Global System for Mobile (GSM) communications network, a Code Division Multiple Access (CDMA) network, an Nth generation mobile communication network, where “N” may be 2, 3, 4, 5, 6, etc., a Long-Term Evolution (LTE) mobile communication network, a public telephone network, etc., a Local Area Network (LAN), a Wide Area Network (WAN), an infrared communication network, etc., or a network formed from any combination of these networks.

In still further embodiments, the RAG-based query assistance system 512 may include a Language Model (LM) integration framework 514 that implements one or more AI models, for example, the AI model 522. The AI model 522 may include, for example, a Large Language Model (LLM). In still additional embodiments, the AI model 522 may refer to an API or a language model, for example, the ChatGPT API variants of OpenAI OpCo, LLC or other APIs, configured to generate human-like text based on input prompts. In some more embodiments, the LM integration framework 514 may allow the integration of the LLM into a workflow for knowledge-integrated query assistance. The LM integration framework 514 may transmit a prompt associated with a query, to the AI model 522 and receive a response with coherent and contextually appropriate text therefrom. The LM integration framework 514 may abstract the complexities of operating the LLM, such as managing memory, chaining tasks, and integrating external data, thereby enhancing the development of the meeting application. In yet various embodiments, the LM integration framework 514 may define a standard interface for operating LLMs, thereby allowing a plug-in of any model, for example, a Generative Pre-trained Transformer (GPT) such as ChatGPT® of OpenAI OpCo, LLC, Cohere® models of Cohere Inc., Hugging Face® models of Hugging Face, Inc., or the like, that adheres to this interface. In yet more embodiments, the LM integration framework 514 may provide wrappers for various LLMs, to allow convenient connection and transmission of requests to the LLMs for text generation or other NLP tasks.

In still yet more embodiments, the LM integration framework 514 may allow customization of prompts for specific tasks, thereby facilitating precise control of the behavior of the LLMs. The prompts may include, for example, dynamic prompts, developed based on previous responses or external inputs, allowing for more complex and context-sensitive responses to the queries. The LM integration framework 514 may also allow interaction with external tools, databases, or APIs, and utilization of the LLMs for reasoning, decision-making, or generating content such as responses to the queries. In many further embodiments, the LM integration framework 514 may include built-in support for memory, allowing the LLM to maintain context across multiple interactions. In these embodiments, the LLM may be configured to remember previous interactions to generate coherent responses to the queries. The LM integration framework 514 may support RAG-based workflows, where the LLM may retrieve relevant, up-to-date, or specialized information from external sources that may not be directly encoded in the LLM itself, before generating a response, thereby improving the quality and relevance of the output of the LLM. The external sources may include, for example, databases such as Structured Query Language (SQL) databases, document stores, web scraping tools, cloud storage, search engines, file storage, APIs, other models, or the like. The LM integration framework 514 may, for example, be a LangChain® language model integration framework of LangChain Inc.

In an exemplary implementation of the system 500, the LM integration framework 514 may include a vectorization module 516 and a vector store 518. The vectorization module 516 may be configured as an embedding generator, for example, a Hugging Face® embedding generator, to vectorize the meeting content and store the vectorized meeting content in the vector store 518. The vectorization module 516 may receive the meeting content, tokenize the meeting content into smaller chunks of data or tokens, for example, words or subwords, and pass the tokens as input text through a transformer-based model such as Bidirectional Encoder Representations from Transformers (BERT), Robustly optimized BERT approach (ROBERTa), DistilBERT, or the like. The transformer-based model may process the input text, for example, through multiple layers of attention and neural network operations, learning to capture the relationships between the tokens and the overall meaning. After processing the input text, the transformer-based model may generate a set of output embeddings that are vector representations of each token in the input text. In many additional embodiments, the embeddings can also be aggregated to represent the entire input, for example, by utilizing average pooling or by utilizing an embedding of a special classification (CLS) token. The resulting embeddings, herein referred to as “vector embeddings,” may be numerical vectors in a high-dimensional space, for example, 256, 512, or 1024 dimensions, which capture a semantic meaning of the original input text. The vector embeddings may represent the meeting content numerically to allow the AI model 522 to understand text in the queries and generate responses. The vector store 518 may be an embedding database configured for storage and retrieval of the vector embeddings. In an example, the vector store 518 may be an open-source AI application database such as ChromaDB of Chroma Inc. The vector store 518 may be configured for operation with the AI model 522. The vector store 518 may store the vector embeddings along with metadata to be utilized later by the AI model 522. Utilizing the AI model 522 in conjunction with the LM integration framework 514 including the vector store 518, the meeting application may employ a RAG-based pipeline to provide accurate and contextually relevant responses to the queries of the participants 506A-506C in real time or near-real time. In still yet further embodiments, the RAG-based query assistance system 512 may preserve individual chat context by storing chat history per session in a context database 520, for example, the mongoDB® document database of MongoDB, Inc., ensuring that the AI model 522 can maintain context and continuity throughout the meeting.

Consider an example where the system 500 may be implemented for providing knowledge-integrated query assistance in a meeting environment. In still yet additional embodiments, the facilitator 502 may download a meeting application 508A associated with the AI-based query assistance logic on the user device 504 from the meeting application platform 508 via the network. Prior to an initiation of the meeting, the facilitator 502 may upload meeting content 524 to the meeting application platform 508 via the meeting application 508A installed on the user device 504. The meeting content 524 may include, for example, presentation files, documents, notes, or the like associated with the meeting. The meeting application 508A may format the meeting content 524 and transmit the formatted meeting content 526 to the meeting application platform 508. On receiving the formatted meeting content 526, the meeting application platform 508 may transmit a response 528 to the meeting application 508A, acknowledging reception of the formatted meeting content 526. Uploading the meeting content 524 associated with the meeting prior to the initiation of the meeting may allow the meeting application platform 508 to be well-prepared with the meeting content even before the meeting begins. This preparation may lead to more efficient and productive meetings, as the participants 506A-506C can receive informed responses to their queries quickly and accurately based on knowledge integration in the system 500. The meeting application platform 508 may then transmit the received meeting content 530 to the web server 510. In several embodiments, the web server 510 may preprocess, validate, and sanitize the received meeting content 530 prior to transmitting the meeting content 534 to the RAG-based query assistance system 512. The vectorization module 516 in the LM integration framework 514 of the RAG-based query assistance system 512 may receive and vectorize the meeting content 534 and store the vectorized meeting content in the vector store 518.

The facilitator 502 may host a meeting through the meeting application 508A on the user device 504 where the meeting content 524 is presented. During the meeting, the meeting application 508A may receive at least one query 536 associated with the meeting content 524 from one or more of the participants 506A-506C and transmit the query 536 to the meeting application platform 508. The meeting application platform 508 may transmit the query 536 to the web server 510, for example, as input text 538. The web server 510 may receive the input text 538 from the meeting application platform 508 and validate the input text 538, for example, by checking for completeness of the input text 538 and by filtering the input text 538. In several more embodiments, the web server 510 may normalize the input text 538 for convenient processing by the AI model 522. The web server 510 may normalize the input text 538, for example, by converting text to lowercase, removing extraneous whitespace, special characters, or formatting issues, handling abbreviations, contractions, or synonyms to reduce ambiguity, or the like. In numerous embodiments, the web server 510 may utilize predefined templates to structure the input text 538 into a prompt 540. For example, the web server 510 may utilize a predefined template such as “Answer the following question based on the given text: {input_text}” to generate the prompt 540. In numerous additional embodiments, the web server 510 may also deduce the intent behind the input text 538 such as “asking a query” and adjust the prompt 540 accordingly. The web server 510 may transmit the prompt 540 to the RAG-based query assistance system 512.

In many embodiments a data pathway 532 may be utilized to convey information from the meeting application platform 508 back to the web server 510. It is envisioned that this pathway transmits meeting-related context or metadata, such as real-time transcriptions, captured participant inputs, or relevant session parameters, thereby enabling the web server to construct structured and contextually informed prompts. Within the Retrieval-Augmented Generation (RAG) system 512, this input data is essential for the web server's subsequent interaction with the AI components, facilitating query processing with enhanced accuracy.

In the RAG-based query assistance system 512, the LM integration framework 514 may vectorize the prompt 540 and store the vectorized prompt in the vector store 518. In further additional embodiments, the LM integration framework 514 may access the context database 520 for retrieving chat context from chat history stored in the context database 520. In many embodiments, the LM integration framework 514 may access the context database 520 for retrieving additional context for the meeting based on the meeting content 534 and the query 536. In a number of embodiments, the LM integration framework 514 may access external databases and other repositories of structured or unstructured knowledge, web data, or the like for retrieving the additional context for the meeting. The LM integration framework 514 may augment the vectorized prompt 540 with the retrieved chat context and transmit the augmented prompt 544 to the AI model 522, for example, the LLM. In a variety of embodiments, the LM integration framework 514 may retrieve the vectorized meeting content from the vector store 518 and feed the retrieved meeting content to the AI model 522 for generation of more accurate and context-specific responses. In various embodiments, the LM integration framework 514 may perform a semantic search by comparing the vectorized query with the vectorized meeting content in the vector store 518, to retrieve the most relevant documents or meeting content based on semantic similarity, rather than simple keyword matching. The vector store 518 can index and quickly search for similar vectors using similarity algorithms, which may allow the LM integration framework 514 to find related vectors given a target vectorized query. Furthermore, a data retrieval channel 542 links the context database 520 to the language model integration framework 514. This link allows the framework to fetch contextually relevant documents, historical interaction data, or domain-specific knowledge from the database, without limitation. In a RAG environment, this data may undergo embedding into vector representations, which are used to perform semantic searches for context enrichment. Thus, the retrieved context significantly improves the precision of the augmented prompts sent to the artificial intelligence model 522, enabling it to produce accurate, contextually coherent, and relevant responses to queries originating from the meeting application.

In more embodiments, if the system 500 is part of a conversation, the AI model 522 may utilize memory to remember prior interactions and ensure continuity in the conversation. The AI model 522 may generate a response 546, potentially sending the response 546 through additional processing steps such as summarization or formatting, before transmitting the processed response 548 to the web server 510 via the LM integration framework 514. At this stage, the processed response 548 may be in a natural language form. The web server 510 may structure the processed response 548 in a manner understandable to the meeting application platform 508 and generate a structured output 550. For example, the web server 510 may format the processed response 548 by utilizing JavaScript Object Notation (JSON), rich media, a markup language such as Markdown, or the like depending on the type of the processed response 548 and the capabilities of the meeting application platform 508. The web server 510 may transmit the structured output 550 to the meeting application platform 508, which may be rendered as an answer 552 to the query 536. The answer 552 may, for example, be generated text or a retrieved document based on the previously vectorized query. Further, in additional embodiments, the RAG-based query assistance system 512 can answer queries that may be beyond a facilitator's 502 understanding about a topic or a question by citing responses from the uploaded meeting content 524.

In further embodiments, the system 500 may be utilized by a participant who may attend multiple meetings like a Chief Executive Officer (CEO). The meeting application 508A may render a dashboard to allow the participant to request data from the meetings, which may be converted into a prompt with a query for each meeting. The facilitator 502 of the meeting may upload the meeting content for each meeting prior to an initiation of each meeting. The facilitator 502 may further enable live transcripts for the meeting. The RAG-based query assistance system 512 may receive the uploaded meeting content and live transcripts, vectorize the uploaded meeting content and live transcripts, and store the vectorized content and live transcripts for each meeting in the vector store 518. The RAG-based query assistance system 512 may generate a response customized to the participant for the meeting content of all the meetings with action items. The response may include, for example, a summary and action items from the meetings selected by the participant.

In an example implementation, the system 500 may be utilized by a tutor for tutoring a student. The tutor may create course materials and upload the course materials to the meeting application platform 508. The system 500 may allow the student to upload documents containing current knowledge and personalizations to the meeting application platform 508. The RAG-based query assistance system 512 may vectorize the uploaded course materials and the student's uploaded documents and store vector embeddings generated therefrom in the vector store 518. In still more embodiments, the RAG-based query assistance system 512 operably coupled to the meeting application platform 508 may be utilized for creating one or more courses using the uploaded course materials, which may be further customized based on the student's uploaded documents. In these embodiments, the RAG-based query assistance system 512 may include a course creator and a course personalizer in operable communication with the LM integration framework 514. The vector embeddings retrieved from the vector store 518 may render the context for creating and personalizing the course(s). The LM integration framework 514 may communicate with the AI model 522, for example, the LLM, to generate comprehensive text-based lecture notes on a wide range of subjects. The AI model 522 may take a topic and generate a detailed, structured explanation, which can serve as the backbone of a lesson or module of the course(s). In still further embodiments, the RAG-based query assistance system 512 may be operably coupled to an interactive application that may allow the student to interact with the course(s).

Although a specific embodiment for a system 500 for knowledge-integrated query assistance in a meeting environment suitable for carrying out the various steps, processes, methods, and operations described herein is discussed with respect to FIG. 5, any of a variety of systems and/or processes may be utilized in accordance with embodiments of the disclosure. For example, other than a RAG-based query assistance system 512, the system 500 may implement other knowledge-integrated systems such as knowledge-based graph systems, external knowledge bases, neural-symbolic systems, fine-tuned LLMs with domain-specific knowledge, hybrid knowledge retrieval and generation, end-to-end memory networks, ontologies and rule-based systems, meta-learning or few-shot learning with knowledge integration, or any combination thereof to provide knowledge-based query assistance in the meeting environment. The elements depicted in FIG. 5 may also be interchangeable with other elements of FIGS. 1-4 and FIGS. 6-11 as required to realize a particularly desired embodiment.

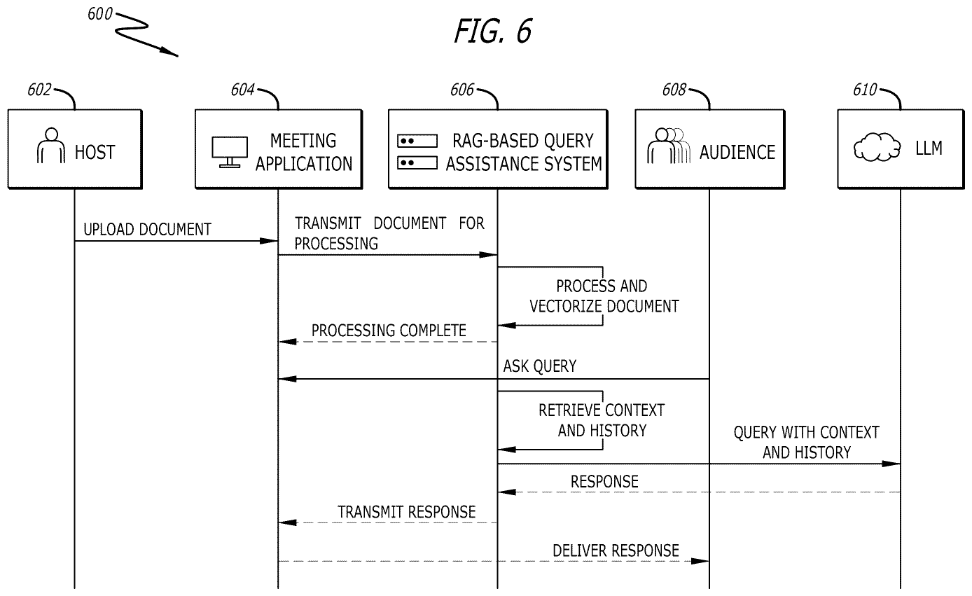

Referring to FIG. 6, a message flow diagram 600 illustrating provision of knowledge-integrated query assistance in a meeting environment in accordance with various embodiments of the disclosure is shown. In an exemplarily implementation, a RAG-based query assistance system 606 may integrate an AI model, for example, an LLM 610, for knowledge-integrated query assistance in the meeting environment. For purposes of illustration, the present disclosure may refer to employing a RAG-based query assistance system 606 for providing knowledge-integrated query assistance in the meeting environment; however, the scope of the systems, devices, and methods discussed herein may not be limited to the RAG-based query assistance system 606, but may extend to employ any other knowledge-integrated system for providing knowledge-integrated query assistance in the meeting environment. Consider an example where a facilitator such as a host 602 may download a meeting application 604 associated with an AI-based query assistance logic on a user device. The host 602 may utilize the meeting application 604 for hosting a meeting where meeting content is presented. In this example, the meeting content may refer to network diagnostics and troubleshooting. Prior to an initiation of the meeting through the meeting application 604, the host 602 may upload a document, for example, a presentation containing topics related to network diagnostics and troubleshooting to the meeting application 604. In many embodiments, the meeting application 604 may transmit the document to the RAG-based query assistance system 606 for processing. The RAG-based query assistance system 606 may process and vectorize the document. The RAG-based query assistance system 606 may store the vectorized document in a vector store and transmit an indication to the meeting application 604 that the processing is complete.

During the meeting, the host 602 may present the document including the presentation containing topics related to network diagnostics and troubleshooting to an audience 608 via the meeting application 604. One or more participants in the audience 608 may ask a query or a question about the meeting content to the host 602 via the meeting application 604. For example, a participant may ask “Why is my computer unable to access websites even though it's connected to the network?” The RAG-based query assistance system 606 may receive the query and retrieve context and history such as chat history based on the document and the query from a context database. For example, the RAG-based query assistance system 606 may retrieve the context and history such as chat history related to network diagnostics and troubleshooting techniques already performed by the participant, documentation from network devices or Operating System (OS) troubleshooting guides, notes related to potential causes of network access issues such as Domain Name Server (DNS) issues, firewall settings, etc., or the like from the context database. The RAG-based query assistance system 606 may then augment the query with the context and the history and feed the augmented query to the LLM 610. In this example, the augmented query may be “Why is my computer unable to access websites, despite showing as connected to the network? I have already checked the physical connection, and other devices are working fine. Could it be a DNS issue, incorrect Internet Protocol (IP) configuration, or firewall blocking access? I have already tried the following steps: DNS troubleshooting and IP configuration.” The LLM 610 may generate a response to the augmented query and transmit the response to the meeting application 604 via the RAG-based query assistance system 606. The meeting application 604 may deliver the response to the audience 608 during the meeting. In this example, the response may be: “Based on your detailed description, here are some additional steps to troubleshoot the issue of not being able to access websites:
(1) Check DNS Settings: If you cannot resolve domain names using nslookup, it may indicate a DNS problem. Try manually setting your DNS to a public server such as Google DNS (8.8.8.8) or Cloudflare (1.1.1.1) and test again.
(2) Check IP Configuration: Ensure that your computer is receiving a valid IP address from the DHCP server. If you are using a static IP, confirm that it is within the correct subnet range. You can also try releasing and renewing your IP address using ipconfig/release and ipconfig/renew.
(3) Firewall Inspection: Sometimes firewalls can block web traffic, especially HTTP/HTTPS ports. Check your firewall rules and make sure that it is not blocking your browser or other apps from accessing the internet. Temporarily disabling the firewall can help test if it is the source of the problem.
(4) Router or Switch Configuration: Since other devices are working fine, it could be worth checking for any device-specific configurations in your router or switch. Look for IP conflicts or misconfigurations that might be affecting only your computer.

By following these steps, you should be able to identify the source of the issue and restore access to websites on your computer.”

Although a specific embodiment for provision of knowledge-integrated query assistance in a meeting environment suitable for carrying out the various steps, processes, methods, and operations described herein is discussed with respect to FIG. 6, any of a variety of systems and/or processes may be utilized in accordance with embodiments of the disclosure. For example, in a number of embodiments, reinforcement learning may be utilized for query optimization, performance tuning, and user guidance to improve the relevance of responses over time. The RAG-based query assistance system 606 may employ reinforcement learning to refine and optimize responses to queries from the audience 608 by learning from feedback from the host 602 and/or the audience 608, improving context retrieval accuracy over time. The reinforcement learning-based approach may dynamically adjust query handling, increasing the responsiveness of the RAG-based query assistance system 606 and relevance by applying positive or negative feedback from meeting interactions. The elements depicted in FIG. 6 may also be interchangeable with other elements of FIGS. 1-5 and FIGS. 7-11 as required to realize a particularly desired embodiment.

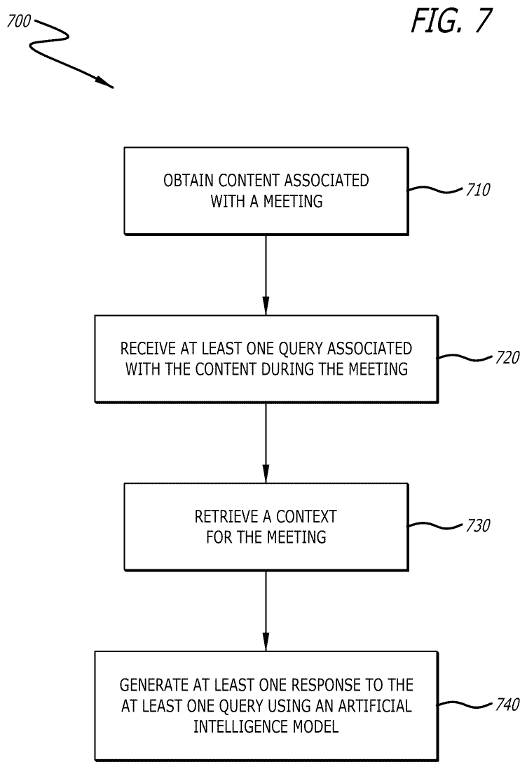

Referring to FIG. 7, a flowchart depicting a process 700 for knowledge-integrated query assistance in a meeting environment in accordance with various embodiments of the disclosure is shown. In the meeting environment where professional meetings and presentations including, for example, team meetings, project demonstrations, knowledge transfer sessions, or the like are held, the process 700 may streamline the flow of information and communication by implementing an AI-based query assistance logic integrated with a meeting application platform, for example, a web conferencing platform, a video conferencing platform, or the like. The meeting application platform may host a meeting application accessible to a facilitator and participants of a meeting, for example, a virtual meeting, on one or more user devices. In many embodiments, the process 700 may obtain content associated with a meeting (block 710). The content may include, for example, presentation files, documents, notes, or the like associated with the meeting. The process 700 may obtain the content through the meeting application deployed on the facilitator's user device. In a number of embodiments, the content may be obtained prior to an initiation of the meeting. In a variety of embodiments, the content may be obtained during the meeting.

In various embodiments, the process 700 may receive at least one query associated with the content during the meeting (block 720). The process 700 may receive the query from one or more participants of the meeting through their respective meeting applications. In more embodiments, the process 700 may receive the query via a user interface rendered by each meeting application. The user interface may include, for example, a chat interface, an audio interface, a video interface, or the like.

In additional embodiments, the process 700 may retrieve a context for the meeting (block 730). The process 700 may retrieve the context for the meeting based on the content and the query. In further embodiments, the process 700 may retrieve the context for the meeting from a context database. The context database may, for example, be the mongoDB® document database. In still more embodiments, the context database may store chat history per session ensuring that an AI model can maintain the context and continuity throughout the meeting. In still further embodiments, at least part of the retrieved context may be based on the stored chat history. In still additional embodiments, at least part of the retrieved context may be based on a vectorized transcript. In some more embodiments, the process 700 may update the context of the meeting in the context database based on a progress of the meeting.

In yet various embodiments, the process 700 may generate at least one response to the at least one query using an artificial intelligence model (block 740). The process 700 may generate at least one response to the query based on the retrieved context. The process 700 may execute the AI model to generate the response(s) to the query. The AI model may, for example, be an LLM. In yet more embodiments, the response(s) to the query may be generated based on RAG. The process 700 may support RAG-based workflows, where the LLM may retrieve relevant, up-to-date, or specialized information from the context database and/or external sources that may not be directly encoded in the LLM itself, before generating the response(s), thereby improving the quality and relevance of the output of the LLM. In still yet more embodiments, the process 700 may generate one or more prompts for the LLM based on the retrieved context; and input the prompt(s) to the LLM, where the response(s) to the query may be generated based on an output of the executed LLM for the prompt(s). The process 700 may render the response(s), on the user interface associated with the meeting, in at least one of real-time or near-real time. Obtaining the content associated with the meeting prior to an initiation of the meeting may allow the process 700 to be well-prepared with information even before the meeting begins. This preparation may lead to more efficient and productive meetings, as the participants can receive informed responses to their queries quickly and accurately based on RAG. In many further embodiments, the process 700 may be configured to store history of the meeting in the context database.

Although a specific embodiment for a process 700 for knowledge-integrated query assistance in a meeting environment suitable for carrying out the various steps, processes, methods, and operations described herein is discussed with respect to FIG. 7, any of a variety of systems and/or processes may be utilized in accordance with embodiments of the disclosure. For example, other than an LLM, the process 700 may implement another AI model, for example, a Language model with Attention Mechanism (LAM) that may focus on different parts of the query with varying degrees of importance, enabling the AI model to better capture long-range dependencies and relationships in the text of the query. The attention mechanism may allow the AI model to selectively focus on certain parts of the query while generating a response, making the AI model more effective in understanding context, handling long-term dependencies, complex relationships, and improving the response. The elements depicted in FIG. 7 may also be interchangeable with other elements of FIGS. 1-6 and FIGS. 8-11 as required to realize a particularly desired embodiment.

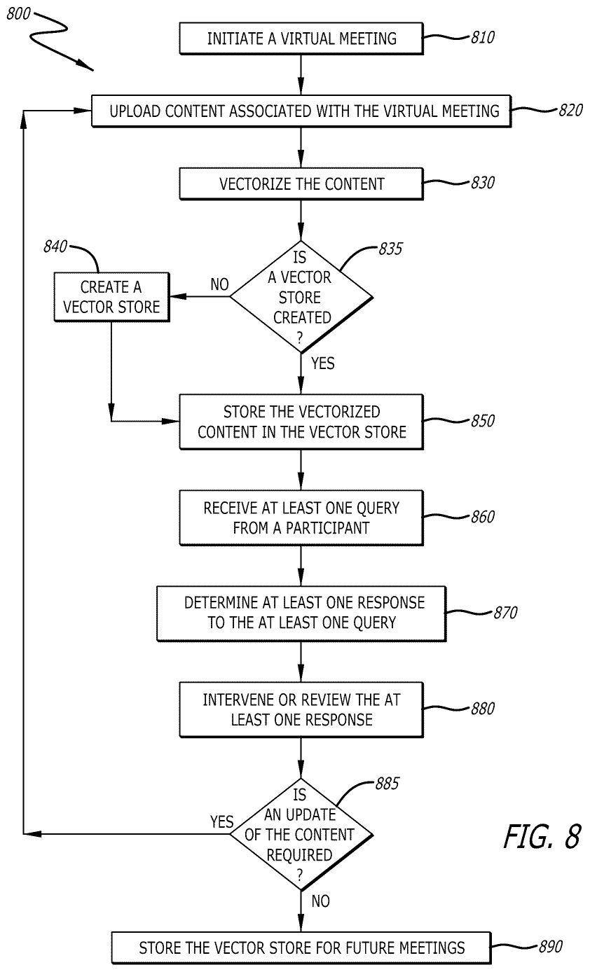

Referring to FIG. 8, a flowchart depicting a process 800 for knowledge-integrated query assistance in a meeting environment based on actions of a facilitator of a meeting in accordance with various embodiments of the disclosure is shown. In the meeting environment where professional meetings and presentations including, for example, team meetings, project demonstrations, knowledge transfer sessions, or the like are held, the process 800 may streamline the flow of information and communication by implementing an AI-based query assistance logic integrated with a meeting application platform, for example, a web conferencing platform, a video conferencing platform, or the like. The meeting application platform may host a meeting application accessible to the facilitator, for example, a moderator, a host, or a presenter, and participants of a meeting, for example, a virtual meeting, on one or more user devices. In many embodiments, the process 800 may initiate a virtual meeting (block 810). The virtual meeting may allow the facilitator to meet, collaborate on meeting content rendered, for example, through a presentation, and communicate with the participants without being physically present in the same location. The process 800 may initiate the virtual meeting through the meeting application. The facilitator may launch the meeting application on a user device, login to a user account created with the meeting application platform, and click a link, for example, “Start a meeting,” on a user interface of the meeting application.

In a number of embodiments, the process 800 may upload content associated with the virtual meeting (block 820). The content may include, for example, presentation files, documents, notes, or the like associated with the virtual meeting. The process 800 may upload the content through the meeting application deployed on the facilitator's user device. In a variety of embodiments, the content may be uploaded prior to an initiation of the meeting. In various embodiments, the content may be uploaded during the meeting.

In more embodiments, the process 800 may vectorize the content (block 830). The process 800 may utilize a vectorization module of an LM integration framework to vectorize the content. The vectorization module may be configured as an embedding generator, for example, a Hugging Face® embedding generator, to vectorize the content. The process 800 may receive the uploaded content, tokenize the uploaded content into smaller chunks of data or tokens, for example, words or subwords, and pass the tokens as input text through a transformer-based model such as Bidirectional Encoder Representations from Transformers (BERT), Robustly optimized BERT approach (ROBERTa), DistilBERT, or the like. The transformer-based model may process the input text, for example, through multiple layers of attention and neural network operations, learning to capture the relationships between the tokens and the overall meaning. After processing the input text, the transformer-based model may generate a set of output embeddings that are vector representations of each token in the input text. The output embeddings, herein referred to as “vector embeddings,” may be numerical vectors in a high-dimensional space, for example, 256, 512, or 1024 dimensions, which capture a semantic meaning of the original input text. The vector embeddings may represent the uploaded content numerically to allow an AI model, for example, an LLM, to understand text in queries and generate responses.

In additional embodiments, the process 800 may determine whether a vector store is created (block 835). The process 800 may determine whether the vector store is created for storage of the vectorized content, also referred to as “vector embeddings.” The vector store may be an embedding database configured for storage and retrieval of the vector embeddings. In an example, the vector store may be an open-source AI application database such as ChromaDB of Chroma Inc.

In further embodiments, in response to determining that the vector store is not created, the process 800 may create a vector store (block 840) and store the vectorized content in the vector store (block 850). The process 800 may create the vector store, for example, by installing libraries such as Python libraries. In an example, for ChromaDB, the process 800 may install Chroma, Facebook AI Similarity Search (FAISS), or other vector search libraries for creating the vector store. The process 800 may then initialize the vector store, for example, with Chroma. In still more embodiments, the process 800 may optimize the vector store for faster retrieval based on the scale. The process 800 may utilize, for example, indexing methods such as FAISS or Hierarchical Navigable Small World (HNSW) graphs for optimal nearest-neighbor searches. In still further embodiments, the process 800 may consider distance metrics for vector similarity including, for example, cosine similarity, Euclidean distance, and dot product. In still additional embodiments, the process 800 may ensure that the vector store is persistent, that is, the content is stored, by configuring an appropriate storage backend, for example, using local storage or cloud databases.

In some more embodiments, in response to determining that the vector store is created, the process 800 may store the vectorized content in the vector store (block 850). In yet various embodiments, the process 800 may store the vectorized content along with their associated metadata in the vector store. The metadata may include, for example, document or image titles, descriptions, tags, dates and timestamps when the content was created, source Uniform Resource Locators (URLs), authors, categories, or the like. The process 800 may store the metadata, for example, in a key-value pair format, where the key may be an identifier (ID) such as a vector ID and the value may be the metadata. In yet more embodiments, the process 800 may store the vectorized content, the associated metadata, and the original uploaded content in the vector store. The process 800 may store the vectorized content along with their unique vector IDs in the vector store for referencing and retrieval of the vectorized content. In still yet more embodiments, the process 800 may store the vectorized content as a dense array of floating-point numbers in the vector store, where each floating-point number may represent a specific dimension of the vectorized content or vector. The size of the array may correspond to the dimensionality of an embedding space. For example, BERT embeddings may have 768 dimensions, while some other models may utilize 512 or 1024 dimensions. In many further embodiments, the process 800 may store the vectorized content in compressed formats, for example, by utilizing quantization methods such as Product Quantization (PQ) or application of binary embeddings, to reduce a storage size and increase efficiency.

In many additional embodiments, the process 800 may receive at least one query from a participant (block 860). The process 800 may receive the query from the participant of the meeting through a corresponding meeting application. In still yet further embodiments, the process 800 may receive the query via the user interface rendered by the meeting application. The user interface may include, for example, a chat interface, an audio interface, a video interface, or the like.

In still yet additional embodiments, the process 800 may determine at least one response to the at least one query (block 870). The process 800 may determine at least one response to the query based on a context. The process 800 may retrieve the context for the meeting based on the uploaded content and the query. In several embodiments, the process 800 may retrieve the context for the meeting from a context database. The context database may, for example, be the mongoDB® document database. In numerous embodiments, the context database may store chat history per session ensuring that the AI model can maintain the context and continuity throughout the meeting. In numerous additional embodiments, at least part of the retrieved context may be based on the stored chat history. In further additional embodiments, at least part of the retrieved context is based on the vectorized content. In many embodiments, at least part of the retrieved context may be based on a vectorized transcript. In a number of embodiments, the process 800 may update the context of the meeting in the context database based on a progress of the meeting.

The process 800 may execute the AI model to generate the response(s) to the query. The AI model may, for example, be an LLM. In a variety of embodiments, the response(s) to the query may be generated based on RAG. The process 800 may support RAG-based workflows, where the LLM may retrieve relevant, up-to-date, or specialized information from the context database and/or external sources that may not be directly encoded in the LLM itself, before generating the response(s), thereby improving the quality and relevance of the output of the LLM. In various embodiments, the process 800 may generate one or more prompts for the LLM based on the retrieved context; and input the prompt(s) to the LLM, where the response(s) to the query may be determined based on an output of the executed LLM for the prompt(s). The process 800 may render the response(s), on the user interface associated with the meeting, in at least one of real-time or near-real time.

In more embodiments, the process 800 may intervene or review the at least one response (block 880). In additional embodiments, the process 800 may provide an option to the facilitator to intervene while the response(s) is being rendered to the participant during the meeting. In further embodiments, the process 800 may provide an option to the facilitator to review the response(s) and provide feedback. In still more embodiments, the process 800 may employ reinforcement learning to refine and optimize the response(s) to the query by learning from the feedback provided by the facilitator, improving context retrieval accuracy over time.

In still further embodiments, the process 800 may determine whether an update of the content is required (block 885). In still additional embodiments, the process 800 may determine whether an update of the content is required, if the process 800 receives negative feedback on the determined response(s) to the query from the facilitator. In some more embodiments, the process 800 may determine whether an update of the content is required, if the process 800 determines that the content related to the query is insufficient to generate the response(s). As queries from the participants evolve or as patterns such as new topics, emerging trends, new products, or the like emerge, the vector store may need to update or add new vectors to handle these queries. If the original content does not sufficiently cover the updated queries, the process 800 may update the stored vectorized content for determining relevant responses. Further, if the content being queried is dynamic and frequently updated, for example, in the case of news articles, stock prices, weather reports, or the like, the response(s) should reflect the most recent information. If the underlying content changes, the vector store must be updated with new vector embeddings and metadata to ensure the process 800 can return accurate and up-to-date results. If there was an error in the initial content or if the content has been revised or corrected, the vectorized representation must be updated to reflect the new or corrected content to ensure the response(s) to the query is accurate and trustworthy.

In yet various embodiments, in response to determining that the update of the content is required, the process 800 may proceed to upload the content associated with the virtual meeting (block 820). In an example, the process 800 may prompt the facilitator to upload updated content to allow the process 800 to determine an appropriate response(s) to the query. In a further example, as queries from the participants evolve or as patterns such as new topics, emerging trends, new products, or the like emerge, the process 800 may prompt the facilitator to upload new content to handle these queries. In a still further example, if the process 800 determined an error in the initial content, the process 800 may prompt the facilitator to upload revised or corrected content to ensure the response(s) to the query is accurate and trustworthy.

In yet more embodiments, in response to determining that the update of the content is not required, the process 800 may store the vector store for future meetings (block 890). In still yet more embodiments, the process 800 may determine that an update of the content is not required, if the process 800 receives positive feedback on the determined response(s) to the query from the facilitator. The process 800 may allow the facilitator to save the vector store for future meetings. To make the vector store effective for future meetings, in many further embodiments, the process 800 may embed additional temporal or predictive context into the vectorized content stored in the vector store. This additional temporal or predictive content may allow for handling time-sensitive queries and enabling more accurate retrieval for future meetings.

Although a specific embodiment for a process 800 for knowledge-integrated query assistance in a meeting environment based on actions of a facilitator of a meeting suitable for carrying out the various steps, processes, methods, and operations described herein is discussed with respect to FIG. 8, any of a variety of systems and/or processes may be utilized in accordance with embodiments of the disclosure. For example, in many additional embodiments, the process 800 may utilize the output of the LLM to generate another query that may be rendered to a local system or an external system for generating a response. The elements depicted in FIG. 8 may also be interchangeable with other elements of FIGS. 1-7 and FIGS. 9-11 as required to realize a particularly desired embodiment.

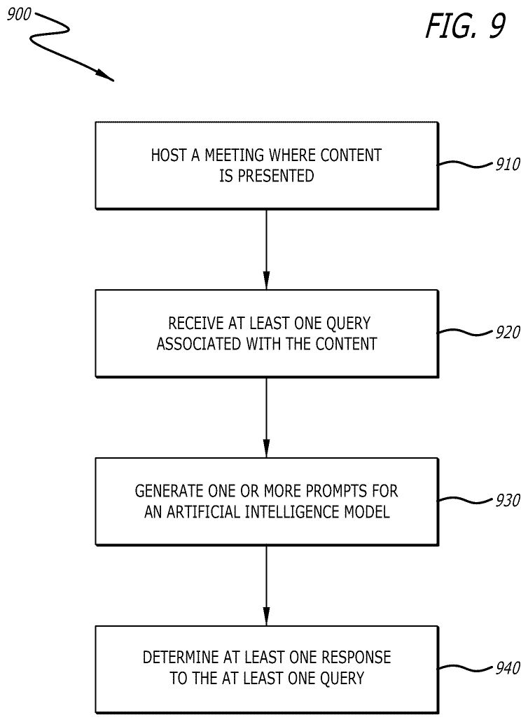

Referring to FIG. 9, a flowchart depicting a process 900 for knowledge-integrated query assistance based on one or more prompts generated for an AI model in accordance with various embodiments of the disclosure is shown. In a meeting environment where professional meetings and presentations including, for example, team meetings, project demonstrations, knowledge transfer sessions, or the like are held, the process 900 may streamline the flow of information and communication by implementing an AI-based query assistance logic integrated with a meeting application platform, for example, a web conferencing platform, a video conferencing platform, or the like. The meeting application platform may host a meeting application accessible to a facilitator, for example, a moderator, a host, or a presenter, and participants of a meeting on one or more user devices.

In many embodiments, the process 900 may host a meeting where content is presented (block 910). The meeting may, for example, be a virtual meeting. The content may include, for example, presentation files, documents, notes, or the like associated with the meeting. The process 900 may receive the content through the meeting application deployed on the facilitator's user device. In a number of embodiments, the process 900 may receive the presented content prior to an initiation of the meeting. In a variety of embodiments, the process 900 may receive the presented content during the meeting.

In various embodiments, the process 900 may receive at least one query associated with the content (block 920). The process 900 may receive the query from one or more participants of the meeting through their respective meeting applications. In more embodiments, the process 900 may receive the query via a user interface rendered by each meeting application. The user interface may include, for example, a chat interface, an audio interface, a video interface, or the like.

In additional embodiments, the process 900 may generate one or more prompts for an artificial intelligence model (block 930). The AI model may, for example, be an LLM. The process 900 may generate the prompt(s) for the AI model based on the query. In further embodiments, the generation of the prompt(s) may be based on a context associated with at least one of: the content, a transcript of the meeting, or a history of the meeting. In still more embodiments, the process 900 may retrieve the context for the meeting from a context database. The context database may, for example, be the mongoDB® document database. In still further embodiments, the context database may store chat history per session ensuring that the AI model can maintain the context and continuity throughout the meeting. In still additional embodiments, at least part of the retrieved context may be based on the stored chat history. In some more embodiments, at least part of the retrieved context is based on vectorized content. In yet various embodiments, at least part of the retrieved context may be based on a vectorized transcript. In yet more embodiments, the process 900 may update the context of the meeting in the context database based on a progress of the meeting. In still yet more embodiments, the process 900 may generate one or more prompts for the AI model based on the retrieved context, and input the prompt(s) to the AI model. The prompt(s) may be a structured input that may combine the query with the retrieved context or knowledge-providing documents from a vector store to allow the AI model to generate an informed and relevant response.

In many further embodiments, the process 900 may determine at least one response to the at least one query (block 940). The process 900 may determine at least one response to the query based on an output of the executed AI model for the prompt(s). In many additional embodiments, the AI model may refer to an API or a language model, for example, the ChatGPT 3.5 Turbo API of OpenAI OpCo, LLC or other APIs, configured to generate human-like text based on input prompts. The process 900 may transmit a prompt associated with a query to the AI model and receive a response with coherent and contextually appropriate text therefrom. In still yet further embodiments, the process 900 may allow customization of prompts for specific tasks, thereby facilitating precise control of the behavior of the AI model. In still yet additional embodiments, the process 900 may support RAG-based workflows, where the AI model may retrieve relevant, up-to-date, or specialized information from external sources that may not be directly encoded in the AI model itself, before generating a response, thereby improving the quality and relevance of the output of the AI model.

Although a specific embodiment for a process 900 for knowledge-integrated query assistance based on one or more prompts generated for an AI model suitable for carrying out the various steps, processes, methods, and operations described herein is discussed with respect to FIG. 9, any of a variety of systems and/or processes may be utilized in accordance with embodiments of the disclosure. For example, in several embodiments, the process 900 may feed the prompt(s) to a combination of AI models, for example, LLMs, LAMs, or the like, to determine at least one response to the query. The elements depicted in FIG. 9 may also be interchangeable with other elements of FIGS. 1-8 and FIGS. 10-11 as required to realize a particularly desired embodiment.

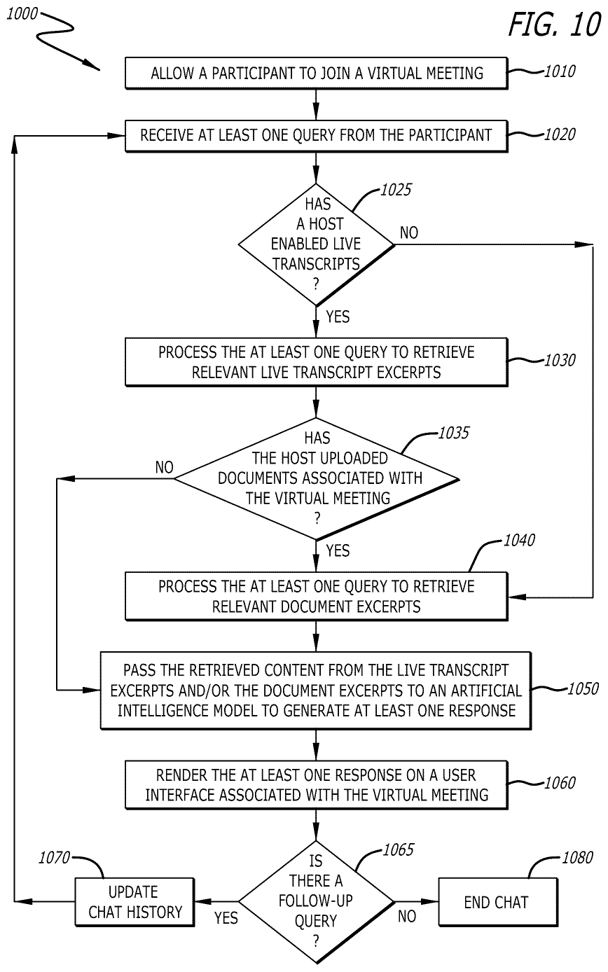

Referring to FIG. 10, a flowchart depicting a process 1000 for knowledge-integrated query assistance in a meeting environment based on actions of a participant of a meeting in accordance with various embodiments of the disclosure is shown. In a meeting environment where professional meetings and presentations including, for example, team meetings, project demonstrations, knowledge transfer sessions, or the like are held, the process 1000 may streamline the flow of information and communication by implementing an AI-based query assistance logic integrated with a meeting application platform, for example, a web conferencing platform, a video conferencing platform, or the like. The meeting application platform may host a meeting application accessible to a facilitator, herein referred to as a “host,” and participants of a meeting, for example, a virtual meeting, on one or more user devices. The host may start the virtual meeting via a user interface of the meeting application and share a meeting link with the participants of the virtual meeting.

In many embodiments, the process 1000 may allow a participant to join a virtual meeting (block 1010). When the host starts the virtual meeting, the participant may join the virtual meeting by accessing the meeting link shared with the participants of the virtual meeting. The participant may click the meeting link to join the virtual meeting and interact with the host and the other participants of the virtual meeting. The participant may view content rendered on a user interface by the host. The content may include, for example, a presentation containing topics.

In a number of embodiments, the process 1000 may receive at least one query from the participant (block 1020). The process 1000 may receive the query from the participant of the meeting through the meeting application. In a variety of embodiments, the process 1000 may receive the query via the user interface rendered by each meeting application. The user interface may include, for example, a chat interface, an audio interface, a video interface, or the like.

In various embodiments, the process 1000 may determine whether the host has enabled live transcripts (block 1025). A live transcript in a virtual meeting may refer to a real-time conversion of words spoken by the host and the participants during the virtual meeting into text. In more embodiments, the meeting application may generate the live transcript by utilizing Automatic Speech Recognition (ASR) technology, which may provide a written record of what is being spoken by the host and the participants throughout the virtual meeting. The meeting application may automatically store the live transcript in a separate database, for example, a context database, with each sentence tagged to its respective timestamp. The live transcript may provide accessibility by helping participants who are deaf or hard of hearing follow a conversation, offering an on-the-fly, searchable written record of what was discussed, and allowing the participants to refer to the text instead of trying to recall every detail of the conversation. The process for generating live transcripts may depend on the meeting application platform being utilizing for the virtual meeting. The live transcripts may be displayed on the user interface in real time or near-real time, as the virtual meeting progresses.

In additional embodiments, in response to determining that the host has enabled live transcripts, the process 1000 may process the at least one query to retrieve relevant live transcript excerpts (block 1030). The live transcript excerpts may be linked to corresponding timestamps. The live transcript excerpts may include quotes from the live transcript with hyperlinks or pointers to the exact timestamps. If the host has enabled live transcripts, the meeting application may generate a live transcript of the virtual meeting. The process 1000 may receive the live transcript, vectorize the received transcript, and store the vectorized transcript in a vector store. The vector store may be an embedding database configured for storage and retrieval of vectorized transcripts also referred to as “vector embeddings.” In an example, the vector store may be an open-source AI application database such as ChromaDB of Chroma Inc. The process 1000 may process the query received from the participant to retrieve live transcript excerpts from the vectorized transcript stored in the vector store. The vector store may allow for optimal similarity-based retrieval of live transcript excerpts based on the query. In further embodiments, each live transcript excerpt may be associated with a timestamp or some form of metadata to indicate when in the virtual meeting the live transcript excerpt occurred, which allows for time-based filtering when retrieving the live transcript excerpts in the future.

In several embodiments, after processing the query to retrieve relevant live transcript excerpts, the process 1000 may determine whether the host uploaded documents associated with the virtual meeting (block 1035). The documents may refer to content associated with the virtual meeting. The documents may include, for example, presentation files, notes, or the like associated with the virtual meeting. The host may upload the documents through the meeting application deployed on the host's user device. In still further embodiments, the documents may be uploaded prior to an initiation of the virtual meeting. In still additional embodiments, the documents may be uploaded during the meeting. The process 1000 may utilize a vectorization module of an LM integration framework to vectorize the documents. The vectorization module may be configured as an embedding generator, for example, a Hugging Face® embedding generator, to vectorize the documents into a set of output embeddings that are vector representations of text of each document. The output embeddings, herein referred to as “vector embeddings or vectors,” may be numerical vectors in a high-dimensional space, for example, 256, 512, or 1024 dimensions, which capture a semantic meaning of the original text from the documents. The vector embeddings may represent the text from the documents numerically to allow an AI model, for example, an LLM, to understand the text in the query and generate responses. The process 1000 may store the vector embeddings in the vector store. The process 1000 may determine whether the host uploaded documents associated with the virtual meeting by searching through the vector store.

In some more embodiments, in response to determining that the host has uploaded documents associated with the virtual meeting, the process 1000 may process the at least one query to retrieve relevant document excerpts (block 1040). In still more embodiments, in response to determining that the host has not enabled live transcripts, the process 1000 may also process the at least one query to retrieve relevant document excerpts (block 1040). The document excerpts may include, for example, insights from the uploaded documents. The process 1000 may process the query received from the participant to retrieve relevant document excerpts from the vectorized documents stored in the vector store. The vector store allows for optimal similarity-based retrieval of the relevant document excerpts based on the query. When the query is received, the process 1000 may perform the similarity-based retrieval by comparing a vector of the query with the vectors of the documents stored in the vector store. The process 1000 may identify the stored vectors that are most similar to the vector of the query, thereby retrieving relevant document excerpts.

In yet various embodiments, after processing the query to retrieve relevant document excerpts, the process 1000 may pass the retrieved content from the live transcript excerpts and/or the document excerpts to an artificial intelligence model to generate at least one response (block 1050). Also, in yet more embodiments, in response to determining that the host has not uploaded documents associated with the virtual meeting, the process 1000 may pass the retrieved content from the live transcript excerpts or the document excerpts to an artificial intelligence model to generate at least one response (block 1050). The AI model may, for example, be an LLM. In still yet more embodiments, the response(s) to the query may be generated based on RAG. The process 1000 may support RAG-based workflows, where the LLM may utilize the retrieved content from the live transcript excerpts and/or the document excerpts that may not be directly encoded in the LLM itself, before generating the response(s), thereby improving the quality and relevance of the output of the LLM. In many further embodiments, the process 1000 may generate one or more prompts for the LLM based on the retrieved content; and input the prompt(s) to the LLM, where the response(s) to the query may be determined based on an output of the executed LLM for the prompt(s).

In many additional embodiments, the process 1000 may render the at least one response on a user interface associated with the virtual meeting (block 1060). The process 1000 may render the response(s) as an answer to the query on the user interface of the meeting application in at least one of real-time or near-real time. In still yet further embodiments, the process 1000 may tag one or more sentences in each live transcript or document with a respective timestamp, and render, on the user interface associated with the meeting, the response(s) with a navigation pointer corresponding to the respective timestamp of the sentence(s) in the live transcript or the document(s). The participant may click on the navigation pointer to navigate directly to a particular part of the live transcript associated with the meeting. In still yet additional embodiments, the process 1000 may provide an option to the host to review the response(s) and provide feedback. The host may monitor the response(s) generated for the query based on the content from the live transcript excerpts and/or the document excerpts. In several embodiments, the process 1000 may optionally allow the host to flag key transcript excerpts or validate the response(s) for the query during or after the virtual meeting. In several more embodiments, the process 1000 may employ reinforcement learning to refine and optimize the response(s) to the query by learning from the feedback provided by the facilitator, improving context retrieval accuracy over time.

In numerous embodiments, the process 1000 may determine whether there is a follow-up query (block 1065). Upon rendering the response(s) to the query to the participant, the process 1000 may monitor the virtual meeting for a follow-up query from any one of the participants. The participants may continue reviewing the content being presented by the host via the user interface. The process 1000 may be useful in answering queries that may be beyond the immediate knowledge of the host but are covered within the presented content.

In numerous additional embodiments, in response to determining that there is a follow-up query, the process 1000 may update chat history (block 1070) and proceed to receive at least one query, that is, the follow-up query, from the participant (block 1020). The process 1000 may update the chat history in the context database. The context database may, for example, be the mongoDB® document database. In further additional embodiments, the process 1000 may preserve individual chat context by storing the chat history per session in the context database, ensuring that the LLM can maintain context and continuity throughout the virtual meeting. In many embodiments, in response to determining that there is no follow-up query, the process 1000 may end chat (block 1080). The meeting application may provide a chat panel that may be closed by the participants to end the chat. The action of closing the chat panel may not end the chat for other participants. The chat may remain available for other participants in the virtual meeting.

Although a specific embodiment for a process 1000 for knowledge-integrated query assistance in a meeting environment based on actions of a participant of a meeting suitable for carrying out the various steps, processes, methods, and operations described herein is discussed with respect to FIG. 10 any of a variety of systems and/or processes may be utilized in accordance with embodiments of the disclosure. For example, in a number of embodiments, the process 1000 may have the ability to chain multiple actions such as calls to the LLM, the vector store, the context database, external knowledge bases, other systems, etc., together, to allow development of more complex logic where the output of one task can feed into the next. For example, the output of an LLM could be used to generate a question that is then answered by another system. The elements depicted in FIG. 10 may also be interchangeable with other elements of FIGS. 1-9 and FIG. 11 as required to realize a particularly desired embodiment.

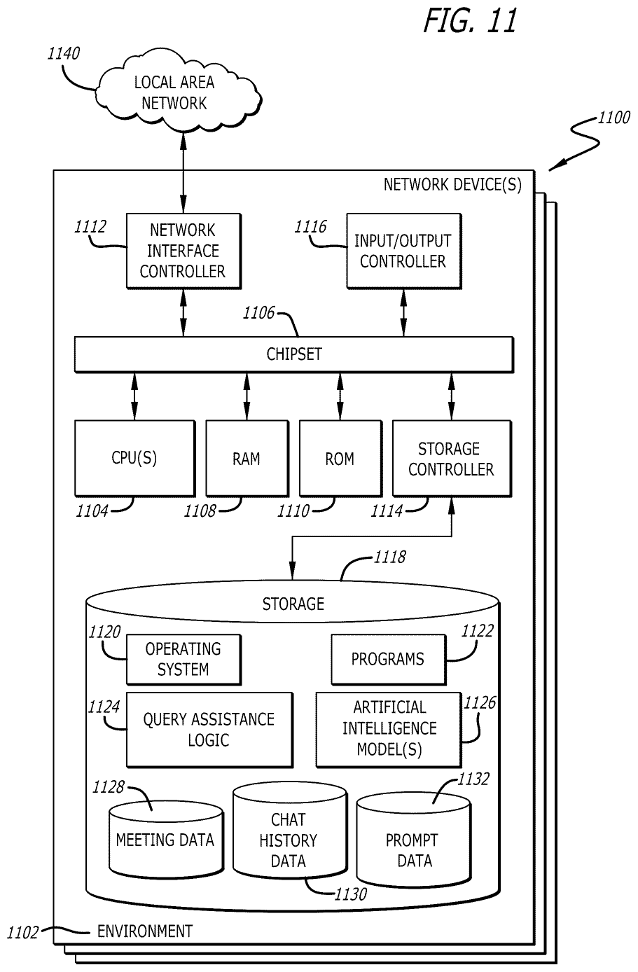

Referring to FIG. 11, a conceptual block diagram of a device 1100 suitable for configuration with a query assistance logic 1124 in accordance with various embodiments of the disclosure is shown. The embodiment of the device 1100 in the conceptual block diagram depicted in FIG. 11 may relate to a conventional server computer, a workstation, a desktop computer, a laptop, a tablet, a network appliance, an electronic reader (e-reader), a smartphone, or other computing device, and can be utilized to execute any of the application and/or logic components presented herein. The device 1100 may, in some examples, correspond to a physical device or to a virtual resource described herein.

In many embodiments, the device 1100 may include an environment 1102 such as a baseboard or a “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In a number of embodiments, one or more processors 1104, such as, but not limited to, CPUs can be configured to operate in conjunction with a chipset 1106. The processor(s) 1104 can be standard programmable CPUs that perform arithmetic and logical operations necessary for the operation of the device 1100.

In a variety of embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1106 may provide an interface between the processor(s) 1104 and the remainder of the components and devices within the environment 1102. The chipset 1106 can provide an interface to a Random-Access Memory (RAM) 1108, which can be utilized as the main memory in the device 1100 in some embodiments. The chipset 1106 can further be configured to provide an interface to a computer-readable storage medium such as a Read-Only Memory (ROM) 1110 or a Non-Volatile RAM (NVRAM) for storing basic routines that can help with various tasks such as, but not limited to, starting up the device 1100 and/or transferring information between the various components and devices. The ROM 1110 or NVRAM can also store other application components necessary for the operation of the device 1100 in accordance with various embodiments described herein.

Different embodiments of the device 1100 can be configured to operate in a networked environment using logical connections to remote computing devices and computer systems through a network, such as the network 1140 (shown as “LAN 1140”). The chipset 1106 can include functionality for providing network connectivity through a Network Interface Controller (NIC) 1112, which may include a gigabit Ethernet adapter or similar component. The NIC 1112 can be capable of connecting the device 1100 to other devices over the network 1140. It is contemplated that multiple NICs 1112 may be present in the device 1100, connecting the device 1100 to other types of networks and remote systems.

In more embodiments, the device 1100 can be connected to a storage 1118 that provides non-volatile storage for data accessible by the device 1100. The storage 1118 can, for example, store an operating system 1120, applications or programs 1122, meeting data 1128, chat history data 1130, and prompt data 1132, which are described in greater detail below. The storage 1118 can be connected to the environment 1102 through a storage controller 1114 connected to the chipset 1106. In additional embodiments, the storage 1118 can include one or more physical storage units. The storage controller 1114 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 1100 can store data within the storage 1118 by transforming the physical state of the physical storage units to reflect the information being stored. The specific transformation of the physical state can depend on various factors. Examples of such factors can include, but are not limited to, the technology utilized to implement the physical storage units, whether the storage 1118 is characterized as primary or secondary storage, and the like. For example, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1100 can further read or access information from the storage 1118 by detecting the physical states or characteristics of one or more particular locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, the operations performed by a cloud computing network, and or any components included therein, may be supported by one or more devices similar to the device 1100. Stated otherwise, some or all of the operations performed by the cloud computing network, and or any components included therein, may be performed by the device 1100 operating in a cloud-based arrangement.

By way of example, and not limitation, computer-readable storage media can include volatile, non-volatile, removable, and non-removable media implemented in any method or technology. Computer-readable storage media includes, but is not limited to, RAM, ROM, Erasable Programmable ROM (EPROM), Electrically-Erasable Programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1118 can store an operating system 1120 utilized to control the operation of the device 1100. According to one embodiment, the operating system 1120 includes the LINUX operating system. According to another embodiment, the operating system 1120 includes the Windows® server operating system from Microsoft Corporation of Redmond, Washington. According to further embodiments, the operating system 1120 can include the UNIX operating system or one of its variants. It should be appreciated that other operating systems can also be utilized. The storage 1118 can store other system or application programs and data utilized by the device 1100.

In still more embodiments, the storage 1118 or other computer-readable storage media is encoded with computer-executable instructions which, when loaded into the device 1100, may transform the device 1100 from a general-purpose computing system into a special-purpose computer capable of implementing the embodiments described herein. These computer-executable instructions may be stored as applications or programs 1122 and transform the device 1100 by specifying how the processor(s) 1104 can transition between states, as described above. In still further embodiments, the device 1100 has access to computer-readable storage media storing computer-executable instructions which, when executed by the device 1100, perform the various processes described above with regard to FIGS. 1-10. In still additional embodiments, the device 1100 can also include computer-readable storage media having instructions stored thereupon for performing any of the other computer-implemented operations described herein.

In some more embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 may not include all of the components shown in FIG. 11, and can include other components that are not explicitly shown in FIG. 11, or may utilize an architecture completely different than that shown in FIG. 11.

As described above, the device 1100 may support a virtualization layer, such as one or more virtual resources executing on the device 1100. In some examples, the virtualization layer may be supported by a hypervisor that provides one or more virtual machines running on the device 1100 to perform functions described herein. The virtualization layer may generally support a virtual resource that performs at least a portion of the techniques described herein.

In yet various embodiments, the device 1100 can include a query assistance logic 1124 that may be responsible for knowledge-integrated query assistance in a meeting environment. In yet more embodiments, the query assistance logic 1124 may operate in an automation system. In embodiments where the device 1100 corresponds to the automation system, the query assistance logic 1124 can be configured to perform various operations such as, but not limited to, obtaining content associated with a meeting such as a virtual meeting, receiving at least one query associated with the content during the meeting, retrieving a context for the meeting based on the content and the query, and generating at least one response to the query using an AI model(s) 1126 based on the retrieved context. In still yet more embodiments where the device 1100 corresponds to the automation system, the query assistance logic 1124 can be configured to perform various operations such as, but not limited to, hosting a meeting where content is presented, receiving at least one query associated with the content, generating one or more prompts for the AI model(s) 1126 based on the query; and determining at least one response to the query based on an output of the AI model(s) 1126 for the one or more prompts.

Those skilled in the art will recognize that the query assistance logic 1124 can include various hardware and/or software deployments and can be configured in a variety of ways. In many additional embodiments, the query assistance logic 1124 can be configured as a standalone device, exist as a logic in another network device, be distributed among various network devices operating in tandem, or remotely operated as part of a cloud-based network management tool. In still yet further embodiments, one or more servers can be configured with the query assistance logic 1124 or can otherwise operate as the query assistance logic 1124. In still yet additional embodiments, the query assistance logic 1124 may operate on one or more servers connected to a communication network, for example, the Internet. The communication network can include wired networks or wireless networks. The query assistance logic 1124 can be provided as a cloud-based service that can service remote networks, such as, but not limited to, a deployed network. Further, in several embodiments, the query assistance logic 1124 may be operated as a distributed logic across multiple network devices. In an embodiment, the controller can operate as the query assistance logic 1124 or may have multiple devices operate as the query assistance logic 1124 in a distributed manner.

In several more embodiments, the storage 1118 can include meeting data 1128. The meeting data 1128 may relate to data representative of content obtained from a facilitator of the meeting. The meeting data 1128 may include content from presentation files, documents, notes, images, audio files, video files, or the like associated with the meeting. In numerous embodiments, the meeting data 1128 may include all data generated, captured, or shared during the meeting, before, during, and after the meeting.

In further additional embodiments, the storage 1118 can include chat history data 1130. The chat history data 1130 may relate to data representative of a context for generating at least one response to at least one query in the meeting environment. The chat history data 1130 may include chat history per session of the meeting. The chat history data 1130 may preserve individual chat context from the meeting, ensuring that the AI model(s) 1126 can maintain context and continuity throughout the meeting. In some more embodiments, the chat history data 1130 may further include transcript data associated with live transcripts generated during the meeting. The chat history data 1130 may be utilized for augmenting the query received from any participant via a meeting application, prior to rendering the augmented query to the AI model(s) 1126 for generating the response(s) to the query.

In many embodiments, the storage 1118 can include prompt data 1132. The prompt data 1132 may relate to data representative of structured input data that may combine the query with the context such as chat history or knowledge-providing documents from a vector store to allow the AI model(s) 1126 to generate an informed and relevant response. The prompt data may include, for example, facilitator-provided context such as feedback. The prompt data may further include, for example, domain knowledge retrieved from external knowledge bases. The prompt data may be utilized to prompt the AI model(s) 1126, which may augment the context of the AI model(s) 1126, providing the AI model(s) 1126 with a more comprehensive understanding of the query. This augmented context may allow the AI model(s) 1126 to generate more precise, informative, and engaging responses to a user's queries.

In a number of embodiments, data may be processed into a format (e.g., feature vectors) usable by the AI model(s) 1126, and/or other pre-processing techniques. In several embodiments, the AI model(s) 1126 may be any type of ML model(s), such as supervised models, reinforcement models, and/or unsupervised models. The ML model(s) 1126 may include one or more of linear regression models, logistic regression models, decision trees, Naïve Bayes models, neural networks, k-means cluster models, random forest models, and/or other types of ML models. The AI model(s) 1126 may include an LLM, an LAM, or the like. In a variety of embodiments, the AI model(s) 1126 may be configured to generate at least one response to at least one query based on the retrieved context. In various embodiments, the AI model(s) 1126 may be configured to analyze the meeting data 1128 and the chat history data 1130 to extract relevant excerpts and enhance the response(s) to the query.

Although a specific embodiment for a device 1100 suitable for configuration with the query assistance logic 1124 for carrying out the various steps, processes, methods, and operations described herein is discussed with respect to FIG. 11, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the query assistance logic 1124 acts in tandem between the devices. The elements depicted in FIG. 11 may also be interchangeable with other elements of FIGS. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel, on the same or on different computing devices, to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
one or more processors; and
a memory communicatively coupled to the one or more processors, wherein the memory comprises a query assistance logic that is configured to:
obtain content associated with a meeting;
receive at least one query associated with the content during the meeting;
retrieve a context for the meeting based on the content and the at least one query; and
generate at least one response to the at least one query using an artificial intelligence model based on the retrieved context.

2. The device of claim 1, wherein the content is obtained prior to an initiation of the meeting.

3. The device of claim 1, wherein the content is obtained during the meeting.

4. The device of claim 1, wherein the query assistance logic is further configured to vectorize the obtained content and store the vectorized content in a vector store, and wherein at least part of the retrieved context is based on the vectorized content.

5. The device of claim 1, wherein the query assistance logic is further configured to:
receive a transcript of the meeting;
vectorize the received transcript; and
store the vectorized transcript in a vector store.

6. The device of claim 5, wherein at least part of the retrieved context is based on the vectorized transcript.

7. The device of claim 1, wherein the query assistance logic is further configured to store history of the meeting in a database.

8. The device of claim 7, wherein at least part of the retrieved context is based on the stored history.

9. The device of claim 1, wherein the at least one response to the at least one query is generated based on retrieval-augmented generation.

10. The device of claim 1, wherein the query assistance logic is further configured to render the at least one response, on a user interface associated with the meeting, in at least one of real-time or near-real time.

11. The device of claim 1, wherein the query assistance logic is further configured to update the context of the meeting in a database based on a progress of the meeting.

12. The device of claim 1, wherein the query assistance logic is further configured to execute the artificial intelligence model to generate the at least one response to the at least one query.

13. The device of claim 12, wherein the artificial intelligence model is a large language model.

14. The device of claim 13, wherein the query assistance logic is further configured to:
generate one or more prompts for the artificial intelligence model based on the retrieved context; and
input the one or more prompts to the artificial intelligence model, wherein the at least one response to the at least one query is generated based on an output of the executed artificial intelligence model for the one or more prompts.

15. The device of claim 1, wherein the meeting is a virtual meeting.

16. A device, comprising:
one or more processors; and
a memory communicatively coupled to the one or more processors, wherein the memory comprises a query assistance logic that is configured to:
host a meeting where content is presented;
receive at least one query associated with the content;
generate one or more prompts for an Artificial Intelligence (AI) model based on the at least one query; and
determine at least one response to the at least one query based on an output of the AI model for the one or more prompts.

17. The device of claim 16, wherein the generation of the one or more prompts is based on a context associated with at least one of: the content, a transcript of the meeting, or a history of the meeting.

18. The device of claim 17, wherein the query assistance logic is further configured to:
tag one or more sentences in the transcript with a respective timestamp; and
render, on a user interface associated with the meeting, the at least one response with a navigation pointer corresponding to the respective timestamp of at least one sentence of the one or more sentences in the transcript.

19. The device of claim 16, wherein the query assistance logic is further configured to receive the presented content prior to an initiation of the meeting.

20. A method, comprising:
obtaining content associated with a meeting;
receiving at least one query associated with the content during the meeting;
retrieving a context for the meeting based on the content and the at least one query; and
generating at least one response to the at least one query using an artificial intelligence model based on the retrieved context.
